(19) United States
(12) Patent Application Publication
(10) Pub. No.: US 2011/0255899 A1
(43) Pub. Date: Oct. 20, 2011

(54) TONER, DEVELOPER, TONER CONTAINER, PROCESS CARTRIDGE AND IMAGE FORMING APPARATUS

(75) Inventors: Yasuaki Iwamoto, Shizuoka (JP); Naohito Shimota, Shizuoka (JP); Naohiro Watanabe, Shizuoka (JP); Satoshi Kojima, Shizuoka (JP); Masana Shiba, Shizuoka (JP)

(73) Assignee: RICOH COMPANY, LTD., Tokyo (JP)

(21) Appl. No.: 13/086,007

(22) Filed: Apr. 13, 2011

(30) Foreign Application Priority Data
Apr. 20, 2010 (JP) 2010-096723

(51) Int. Cl. G03G 9/08; G03G 21/18; G03G 15/08

(52) U.S. Cl. 399/111; 430/108.8; 399/252

(57) ABSTRACT

A toner, including a binder; a colorant; and a wax including a molecular chain constituted of only a C—H bond and a C—C bond, and having a melting point of from 50 to 78° C. and a melt viscosity of from 5 to 15 mPa·S at 140° C., wherein the toner has a weight reduction rate of from 0.001 to 0.1% by weight/min when measured by TGA (Thermogarvimetric Analysis) method in an atmosphere at 165° C. for 10 min.

### BACKGROUND OF THE INVENTION

1. Field of the Invention

The present invention relates to a toner used for electrophotographic image forming apparatus such as copiers, laser printers and facsimiles, and to a developer including the toner, a toner container containing the toner, and a process cartridge and an image forming apparatus including an image developer using the toner.

2. Discussion of the Related Art

Recently, in electrophotographic image forming technology field, development race of (high-definition) color image forming apparatus capable of producing high-definition images at high speed has escalated.

Therefore, as disclosed in Japanese published unexamined applications Nos. 7-209952 and 2000-75551 (Japanese Patents Nos. 3066943 and 4006136, respectively), tandem methods are widely used to produce full-color images at high speed, in which plural electrophotographic photoreceptors are lined in series, each of the photoreceptors forms each color image, the each color images are overlapped on an intermediate transferer, and the overlapped image is transferred onto a recording material.

The intermediate transferer has an effect of preventing direct transfer of background fouling from the photoreceptor onto the recording material such as papers in development, but the two transfer processes, i.e., from the photoreceptor to the intermediate transferer (first transfer) and from the intermediate transferer to the recording material (second transfer) deteriorate in transfer efficiency.

Meanwhile, full-color images having higher quality are required and developers are designed to produce higher quality images. In compliance with this requirement, toners are having smaller particle diameters to precisely reproduce electrostatic latent images formed on photoreceptors. Japanese Patent No. 3640918 and Japanese published unexamined application No. 6-250439 (Japanese Patent No. 3492748) disclose polymerization methods of preparing a toner as means capable of forming a toner having desired shape and surface structure.

The polymerization methods are capable of controlling the shape of a toner besides the particle diameter thereof. Therefore, reproducibility of dot and thin line images improves, and pile height (image layer thickness) can be lowered and higher image quality can be expected.

However, since a toner having a small particle diameter non-electrostatically more adheres to the photoreceptor or the intermediate transferer, the transfer efficiency more deteriorates. Therefore, when a toner having a small particle diameter is used in a high-speed full-color image forming apparatus, particularly the second transfer efficiency noticeably deteriorates. This is because a toner particle more non-electrostatically adheres to the intermediate transferer, plural color toners are overlapped in the second transfer, and the toner particle is in a transfer electric field for shorter time at the second transfer nip.

To solve this problem, the second transfer electric field is thought to be more intensified. However, when too strong, discharge occurs when the intermediate transferer separates from the recording material, and the transfer efficiency rather deteriorates. When the second transfer nip width is wide, the toner particle can be thought to receive a transfer electric field longer. For the contact voltage application methods with a bias roller, etc., the contact pressure or the roller diameter of the bias roller needs increasing to widen the nip width. Increasing the contact pressure or the roller diameter has a limit due to image quality or downsizing of the apparatus, respectively. For the non-contact voltage application methods with a charger, etc., the number of the chargers is increased to widen the nip width, which has a limit. Therefore, it is substantially impossible to widen the nip width to obtain more transfer efficiency particularly in high-speed apparatus.

As means of reducing non-electrostatic adherence between the toner and the photoreceptor or the toner and the intermediate transferer, Japanese published unexamined application No. 2001-066820 (Japanese Patent No. 4076681) and Japanese Patent No. 3692829 disclose methods of controlling additives and the content thereof (particularly including an additive having a larger particle diameter). Thereby, the toner can improve in transfer efficiency with an effect of non-electrostatic adherence reduction, and development stability and cleanability as well.

The toner can initially improve the transfer efficiency. However, when the toner receives mechanical stress such as stirring in an image developer for long periods, the additives are buried in mother toner particles or enter microscopic convexities and concavities present on the surface thereof. Therefore, the additives do not exert an effect of reducing adherence, resulting in deterioration of the transfer efficiency. Particularly, the toner is strongly stirred in the image developer of high-speed apparatus and receives large mechanical stress, resulting in acceleration of burial and invasion of the additives into the mother toner particles. Therefore, the transfer efficiency possibly deteriorates in the early stages. Accordingly, the toner surfaceness needs controlling such that the additives are present on the surface of the mother toner particles without burying and invading therein even when receiving mechanical strength to maintain stable and high transfer efficiency for long periods in high-speed apparatus.

Further, the electrophotographic image forming methods have been used in high-speed printing having a large printed area such as offset printing. Then, it is a point for the electrophotographic image forming methods how a toner image is fixed on a recording material at low energy. In compliance with this, it is important for a toner used therefor to have low fixable temperature and prevent hot offset at high temperature. Japanese Patent No. 3376019 discloses a method of using a polyester resin to decrease the fixable temperature. As methods of preventing hot offset, using a polymeric binder resin to increase the viscoelasticity of a toner, and using a release agent such as waxes to increase the releasability of a toner from a fixing member are known. For example, Japanese Patent No. 3376019 discloses using paraffin waxes and specifying the scope of a melting point by DSC method. Many of them have effects for releasability. In high-speed printing fields, images having a large printed area are required to have high image quality even when printed in large amounts. When the highly-volatile paraffin waxes are used in electrophotographic image forming apparatus printing in large amounts, they contaminate the image forming members and transfer media.

Japanese published unexamined application No. 2005-331925 discloses specifying a loss on heat at 220° C. to improve preservation stability, carrier spent and photoreceptor filming. However, even if the loss on heat at 220° C. is not satisfied, the above problem occasionally does not occur depending on the wax or when the toner is prepared by aqueous granulation. Even when satisfied, the members are contaminated and the recording materials have insufficient separability in high-speed printing. Further, when a paraffin wax having a high melting point is simply used, desired releasability is difficult to obtain, and image quality deteriorates such as occurrence of hot offset and deterioration of glossiness. Simply specifying the melting point of the paraffin wax does not sufficiently prevent contamination of the mage forming apparatus and obtain desired fixability. Full-color images having a high image area ratio are mostly produced at high speed, a heating medium and a transfer medium need to be separated from each other at high speed, and the releasability with a wax without inner contamination is a most important subject.

Japanese published unexamined application No. 2006-195040 discloses using a microcrystalline wax to produce high quality images without uneven image density when fixed. The endothermic peak of the wax and a half bandwidth thereof are further specified to solve the uneven image density. This solves the uneven image density but is disadvantageous for a toner to have low temperature fixability because the wax a high melting point. Only decreasing the endothermic peak of the wax in consideration of the low-temperature fixability leaves a problem of separability of a paper as a recording material from a roller of a fixer at high temperature.

Further, volatile contents generated when a toner is fixed adhere to the inner wall of the apparatus, resulting in occasional malfunction of electronic components. The volatile contents generate from a resin and colorant, which have not been problems recently owing to recent material technologies, but a volatile content from a wax in a toner still remains as a problem. Particularly, the paraffin wax includes many volatile contents and becomes problems in many cases.

Because of these reasons, a need exists for a toner having good low-temperature fixability, good heat-resistant preservability, less volatile contents when fixed, good releasability when fixed at low temperature, good separability between a paper and a roller when fixed at high temperature, and causing less filming.

### SUMMARY OF THE INVENTION

Accordingly, an object of the present invention is to provide a toner having good low-temperature fixability, good heat-resistant preservability, less volatile contents when fixed, good releasability when fixed at low temperature, good separability between a paper and a roller when fixed at high temperature, and causing less filming.

Another object of the present invention is to provide a developer including the toner.

A further object of the present invention is to provide a process cartridge including an image developer containing the toner.

Another object of the present invention is to provide an image forming apparatus including an image developer containing the toner.

To achieve such objects, the present invention contemplates the provision of a toner, comprising:

a binder;

a colorant; and

a wax comprising a molecular chain constituted of only a C—H bond and a C—C bond, and having a melting point of from 50 to 78° C. and a melt viscosity of from 5 to 15 mPa·S at 140° C.,

wherein the toner has a weight reduction rate of from 0.001 to 0.1% by weight/min when measured by TGA (Thermogravimetric Analysis) method in an atmosphere at 165° C. for 10 min.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a transmission electron microscopic picture of the toner of the present invention;

FIG. 2 is a schematic view illustrating an embodiment of the image forming apparatus of the present invention;

FIG. 3 is a schematic view illustrating an image forming means of the image forming apparatus in FIG. 2;

FIG. 4 is a schematic view illustrating an embodiment of the process cartridge of the present invention; and

FIG. 5 is a schematic view illustrating a fixer used in Examples of the present invention.

### DESCRIPTION OF THE PREFERRED EMBODIMENTS

Generally, the present invention provides a toner having good low-temperature fixability, good heat-resistant preservability, less volatile contents when fixed, good releasability when fixed at low temperature, good separability between a paper and a roller when fixed at high temperature, and causing less filming. Particularly, the present invention relates to a toner, comprising:

a binder;

a colorant; and

a wax comprising a molecular chain constituted of only a C—H bond and a C—C bond, and having a melting point of from 50 to 78° C. and a melt viscosity of from 5 to 15 mPa·S at 140° C.,

wherein the toner has a weight reduction rate of from 0.001 to 0.1% by weight/min when measured by TGA (Thermogravimetric Analysis) method in an atmosphere at 165° C. for 10 min.

The toner of the present invention preferably has a weight reduction rate of from 0.001 to 0.1% by weight/min, and more preferably from 0.001 to 0.09% by weight/min when measured by TGA (Thermogravimetric Analysis) method, which prevents the volatile contents in the toner from adhering to the inner wall of the apparatus.

Q5000TGA from TA Instruments can be used to measure the weight reduction rate. A sample to be measured is heated in an atmosphere at from room temperature (25° C.) to 165° C. at 10° C./min, held for 10 min, and further heated up to 300° C. at 10° C./min. The sample preferably has a weight of 0.35 mg. The weight reduction rate is measured until 10 min after the point of reaching 165° C. It is preferably measured in an atmosphere.

The wax has a melting point of from 50 to 78° C., a melt viscosity of from 5 to 15 mPa·S at 140° C., and is preferably a long-chain hydrocarbon including a molecular chain constituted of only a C—H bond and a C—C bond. The long-chain hydrocarbon includes microcrystalline wax, paraffin wax, polyethylene wax, polypropylene wax, Sasol wax, etc. Among these, microcrystalline wax having a low melting point is preferably used because of including less volatile contents when the toner fixed and improving low-temperature fixability of the toner. When a toner includes such waxes, the toner has good friction resistance. A test method of the friction resistance will be mentioned later.

The wax preferably has a difference between a melt viscosity at 100° C. and a melt viscosity at 160° C. of from 1 to 10 mPa·S, and more preferably from 2 to 5 mPa·S. The wax preferably has a low melting point in terms of low-temperature fixability of the toner, and preferably from 50 to 78° C., and more preferably from 60 to 78° C. When less than 50° C., the toner occasionally deteriorates in heat-resistant preservability. When greater than 78° C., cold offset occasionally occurs when the toner is fixed at low temperature.

Further, when the wax is dispersed in a liquid, the wax is melted and cooled in the liquid, and when the wax has a melting point greater than 78° C., the liquid needs to have a boiling point greater than 78° C. When a solvent is used as the liquid, the melting point is occasionally higher than a glass transition temperature of the toner, resulting in possible blocking thereof. The molecular weight of the wax is typically decreased to decrease the melting point thereof. However, when the molecular weight of the wax is simply decreased, the volatile contents increase. Therefore, microcrystalline wax is preferably used because of having a low melting point and less volatile contents.

The melt viscosity of the wax in the present invention is measured by Brookfield viscometer. A sample is heated at from room temperature, and the melt viscosity is preferably a value at not less than a melting point of the sample and at 140° C. similar to actual fixing temperature.

The method of measuring the melting point of the wax will be explained later.

The wax has a weight reduction rate of from 0.005 to 0.5% by weight/min, and more preferably from 0.005 to 0.1% by weight/min when measured by TGA (Thermogarvimetric Analysis) method. When less than 0.005% by weight/min, the wax deteriorates in releasability. When greater than 0.5% by weight/min, volatile contents from the wax increase when the toner is fixed.

The method of measuring the weight reduction rate of the wax is the same as that of the toner.

The total weight of the wax in a toner can be measured by DSC (differential scanning calorimetric) method. A toner sample and a wax sample are subjected to the following measurer and conditions, and the total weight of the wax is determined from a ratio of the endothermic amounts of the toner and the wax.

Measurer: DSC60 from Shimadzu Corp.

Sample Amount: about 5 mg

Heating speed: 10° C./min

Measurement Scope Room temperature to 150° C.

Measurement Environment: In a nitrogen gas atmosphere

The total weight of the wax is determined by the following formula (1):

Wax total weight(% by weigh)=(Endothermic amount of the wax in the toner sample(J/g)×100/Endothermic amount of the wax only(J/g) (1).

The above-mentioned measurement effectively measures the total weight of the wax in a toner even when all the wax is not included in the toner after flowing out while the toner is prepared.

The wax satisfying the above-mentioned conditions probably deteriorates separability between the roller and a paper when the toner is fixed thereon. Therefore, the toner needs to include some gel contents. The gel contents in the toner can improve the separability between the roller and the paper. The gel contents in the toner can be measured as a tetrahydrofuran (THF)-insoluble components. The toner preferably includes the THF-insoluble components in an amount of from 5 to 25% by weight because deteriorations of the separability and low-temperature fixability are prevented.

The THF-insoluble components in a toner can be measured by the following method:

(1) about 1.0 g of a toner is weighed (A);

(2) about 50 g of THF is added to the toner to prepare a solution, and the solution is left for 24 hrs at 20° C.;

(3) the solution is subjected to centrifugal separation and filtered with a filter paper to prepare a filtered liquid; and

(4) the solvent of the filtered liquid is subjected vacuum dry to measure a resin residue amount (B).

The residue amount (B) is THF-soluble contents. The THF-insoluble contents are determined by the following formula (2):

THF-insoluble component(%)=[(A−B)/A]×100 (2)

The binder has adherence to recording materials such as papers, and preferably includes a binder resin and/or a an adhesive polymer (reaction product) formed by emulsifying or dispersing a compound including an active hydrogen group and a polymer (a precursor of the binder resin) reactable with the active hydrogen group in an aqueous medium. When they are included, gel contents can easily be included in a toner. Known binder resins can be used as the binder resin.

The binder resin (including the polymer reactable with the active hydrogen group) preferably has a weight-average molecular weight of from 3,000 to 45,000, more preferably from 4,000 to 30,000, and most preferably from 4,000 to 20,000. When less than 3,000, the toner occasionally deteriorates in hot offset resistance. When the toner includes a polyester resin as a binder, the THF-soluble components preferably has a weight-average molecular weight of from 3,000 to 30,000.

The weight-average molecular weight of the binder resin is measured by a GPC measurer to determine the THF-soluble contents. A column is stabilized in a heat chamber having a temperature of 40° C.; THF is put into the column at a speed of 1 ml/min as a solvent; a sample having a concentration of from 0.05 to 0.6% by weight, is put into the column to measure a molecular weight distribution of the binder resin. From the molecular weight distribution thereof, the weight-average molecular weight and the number-average molecular weight of the binder resin are determined by using a calibration curve which is previously prepared using several polystyrene standard samples having a single distribution peak. As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

The binder resin preferably has a glass transition temperature of from 35 to 65° C., and more preferably from 45 to 65° C. When less than 35° C., the toner occasionally deteriorates in heat resistance preservability. When greater than 65° C., the toner occasionally has insufficient low-temperature fixability. A toner including a crosslinked or an elongated polyester resin as a binder resin has good preservability even though having a low glass transition temperature. A method of measuring the glass transition temperature will be mentioned later.

In the present invention, known binder resins such as polyester resins can be used, and unmodified polyester resin is preferably used. The unmodified polyester resin preferably has an acid value of from 12 to 30 mg KOH/g, and more preferably from 15 to 25 mg KOH/g. Typically, the toner is likely to be negatively charged.

In the present invention, when a toner includes a binder resin formed by emulsifying or dispersing a compound including an active hydrogen group and a polymer reactable with the active hydrogen group in an aqueous medium and an unmodified polyester resin having an acid value less than 12 mg KOH/g, the reaction between the compound and the polymer becomes fast and a liquid including them has high viscosity, resulting in difficulty of emulsification or dispersion in the aqueous medium, the reasons thereof are not clarified, though. When greater than 30 mg KOH/g, the toner deteriorates in hot offset resistance. Known binder resins can be used, and polyester resins are preferably used. The toner of the present invention preferably includes a polyester resin in an amount of from 50 to 100% by weight.

The binder resin precursor is not particularly limited, and modified polyester resins reactable with a compound having an active hydrogen group are preferably used. The modified polyester resin reactable with a compound having an active hydrogen group is preferably polyester having an isocyanate group as a polymer reactable with active hydrogen group. When the polyester resin including an isocyanate group and the compound having an active hydrogen group are reacted with each other, alcohols may be included to form a urethane bond. A molar ratio of the urethane bond to the urea bond (to discriminate from urethane bond polyester prepolymer having an isocyanate groups has) is preferably 0 to 9, more preferably from 1/4 to 4, and most preferably from 2/3 to 7/3. When greater than 9, the toner occasionally deteriorates in hot offset resistance.

Specific examples of the binder resin include a mixture of urea-modified polyester prepolymer with isophoronediamine, produced by reacting a polycondensated product of an adduct of bisphenol A with 2 moles of ethyleneoxide and an isophthalic acid with isophoronediisocyanate, and a polycondensated product of an adduct of bisphenol A with 2 moles of ethyleneoxide and an isophthalic acid; a mixture of urea-modified polyester prepolymer with isophoronediamine, produced by reacting a polycondensated product of an adduct of bisphenol A with 2 moles of ethyleneoxide and an isophthalic acid with isophoronediisocyanate, and a polycondensated product of an adduct of bisphenol A with 2 moles of ethyleneoxide and a terephthalic acid; a mixture of urea-modified polyester prepolymer with isophoronediamine, produced by reacting a polycondensated product of an adduct of bisphenol A with 2 moles of ethyleneoxide and/or bisphenol A with 2 moles of propyleneoxide and a terephthalic acid with isophoronediisocyanate, and a polycondensated product of an adduct of bisphenol A with 2 moles of ethyleneoxide and/or bisphenol A with 2 moles of propyleneoxide and a terephthalic acid; a mixture of urea-modified polyester prepolymer with isophoronediamine, produced by reacting a polycondensated product of an adduct of bisphenol A with 2 moles of ethyleneoxide and/or bisphenol A with 2 moles of propyleneoxide and a terephthalic acid with isophoronediisocyanate, and a polycondensated product of an adduct of bisphenol A with 2 moles of propyleneoxide and a terephthalic acid; a mixture of urea-modified polyester prepolymer with hexamethylenediamine, produced by reacting a polycondensated product of an adduct of bisphenol A with 2 moles of ethyleneoxide and a terephthalic acid with isophoronediisocyanate, and a polycondensated product of an adduct of bisphenol A with 2 moles of ethyleneoxide and an terephthalic acid; a mixture of urea-modified polyester prepolymer with hexamethylenediamine, produced by reacting a polycondensated product of an adduct of bisphenol A with 2 moles of ethyleneoxide and a terephthalic acid with isophoronediisocyanate, and a polycondensated product of an adduct of bisphenol A with 2 moles of ethyleneoxide and/or an adduct of bisphenol A with 2 moles of propyleneoxide and a terephthalic acid; a mixture of urea-modified polyester prepolymer with ethylenediamine, produced by reacting a polycondensated product of an adduct of bisphenol A with 2 moles of ethyleneoxide and a terephthalic acid with isophoronediisocyanate, and a polycondensated product of an adduct of bisphenol A with 2 moles of ethyleneoxide and a terephthalic acid; a mixture of urea-modified polyester prepolymer with hexamethylenediamine, produced by reacting a polycondensated product of an adduct of bisphenol A with 2 moles of ethyleneoxide and an isophthalic acid with diphenylmethanediisocyanate, and a polycondensated product of an adduct of bisphenol A with 2 moles of ethyleneoxide and an isophthalic acid; a mixture of urea-modified polyester prepolymer with hexamethylenediamine, produced by reacting a polycondensated product of an adduct of bisphenol A with 2 moles of ethyleneoxide and/or bisphenol A with 2 moles of propyleneoxide and a terephthalic acid and/or dodecenylsuccinic anhydride with diphenylmethanediisocyanate, and a polycondensated product of an adduct of bisphenol A with 2 moles of ethyleneoxide and/or bisphenol A with 2 moles of propyleneoxide and a terephthalic acid; a mixture of urea-modified polyester prepolymer with hexamethylenediamine, produced by reacting a polycondensated product of an adduct of bisphenol A with 2 moles of ethyleneoxide and an isophthalic acid with toluenediisocyanate, and a polycondensated product of an adduct of bisphenol A with 2 moles of ethyleneoxide and an isophthalic acid, etc.

The compound having an active hydrogen group works as an elongator or a crosslinker when the polymer reactable with the active hydrogen group elongates or crosslinks in an aqueous medium. Specific examples of the active hydrogen group include hydroxyl groups such as alcoholic hydroxyl groups and phenolic hydroxyl groups, amino groups, carboxyl groups, mercapto groups, etc. These can be used alone or in combination. The compound having an active hydrogen group can properly be selected in accordance with the purposes. When the polymer reactable with the active hydrogen group is a polyester prepolymer having an isocyanate group, amines are preferably used because of having higher molecular weight due to elongation or crosslinking reactions with the polyester prepolymer.

Specific examples of the amines include diamines, polyamines having three or more amino groups, amino alcohols, amino mercaptans, amino acids and blocked amines in which the amines mentioned above are blocked.

Specific examples of the diamines include aromatic diamines such as phenylene diamine, diethyltoluene diamine and 4,4′-diaminodiphenyl methane; alicyclic diamines such as 4,4′-diamino-3,3′-dimethyldicyclohexyl methane, diaminocyclohexane and isophoronediamine; aliphatic diamines such as ethylene diamine, tetramethylene diamine and hexamethylene diamine; etc., and their mixtures. Specific examples of the polyamines having three or more amino groups include diethylene triamine, triethylene tetramine, etc., and their mixtures. Specific examples of the amino alcohols include ethanol amine and hydroxyethyl aniline, etc., and their mixtures. Specific examples of the amino mercaptan include aminoethyl mercaptan and aminopropyl mercaptan, etc., and their mixtures. Specific examples of the amino acids include amino propionic acid and amino caproic acid, etc., and their mixtures. Specific examples of the blocked amines include ketimine compounds which are prepared by reacting amines with ketones such as acetone, methyl ethyl ketone and methyl isobutyl ketone; oxazoline compounds, etc., and their mixtures.

A reaction terminator can be used to terminate the elongation or crosslinking reaction between the compound having an active hydrogen group and the polymer reactable therewith. The reaction terminator is preferably used to control the molecular weight of the adhesive base material. Specific examples of the reaction terminator include monoamines such as diethyle amine, dibutyl amine, butyl amine and lauryl amine, and blocked amines, i.e., ketimine compounds prepared by blocking the monoamines mentioned above. A mixing ratio, i.e., a ratio of the isocyanate group in the prepolymer to the amino group in the amine is preferably from 1/3 to 3/1, more preferably from 1/2 to 2/1, and most preferably from 2/3 to 1.5. When the mixing ratio is less than 1/3, the low-temperature fixability of the resultant toner occasionally deteriorates. When greater than 3, the urea-modified polyester resin decreases in molecular weight and the hot offset resistance thereof occasionally deteriorates.

Known resins such as polyol resins, polyacrylic resins, polyester resins, epoxy resins and their derivatives can be used as the polymer reactable with the active hydrogen group (hereinafter referred to as a “prepolymer”). Particularly, the polyester resins are preferably used in terms of high fluidity and transparency. These can be used alone or in combination. Functional groups reactable with the active hydrogen group the prepolymer has include isocyanate groups, epoxy resins, carboxyl groups, functional groups having a formula —COC—, etc. Particularly, the isocyanate groups are preferably used. The prepolymer may include one or more of the functional groups.

The prepolymer is preferably polyester resins having isocyanate groups capable of forming a urea bond because a molecular weight of their polymeric components is easy to control, and they have good oilless low-temperature fixability of a dry toner, i.e., good releasability and fixability without a release oil applicator for a heating medium for fixing. Known polyester resins having isocyanate groups can be used. Specifically, reaction products between polyester resins having an active hydrogen group prepared by polycondensating polyols and polycarboxylic acids, and polyisocyanate can be used.

Known polyols such as diols, tri- or more valent polyols and their mixtures can be used, and diols or mixtures there and a small amount of the tri- or more valent polyols are preferably used. These can be used or in combination.

Specific examples of diols include alkylene glycols such as ethylene glycol, 1,2-propylene glycol, 1,3-propylene glycol, 1,4-butanediol, and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide. In particular, an alkylene glycol having 2 to 12 carbon atoms and adducts of bisphenol with an alkylene oxide are preferably used, and a mixture thereof is more preferably used.

Specific examples of the tri- or more polyols include multivalent aliphatic alcohols having 3 or more valences such as glycerin, trimethylolethane, trimethylolpropane, pentaerythritol and sorbitol; phenols having 3 or more valences such as trisphenol PA, phenolnovolak, cresolnovolak; and adducts of the above-mentioned tri- or more valent polyphenol with an alkylene oxide such as ethylene oxide, propyleneoxide and butyleneoxide. When the diol and the tri- or more polyols are combined, the tri- or more polyols are preferably included in an amount of 0.01 to 10% by weight, and more preferably from 0.01 to 1% by weight.

Known polycarboxylic acids such as dicarboxylic acids, tri- or more valent polycarboxylic acids and their mixtures can be used. Dicarboxylic acids or mixtures thereof and a small amount of the tri- or more valent polycarboxylic acids are preferably used. Specific examples of the dicarboxylic acid include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalene dicarboxylic acid. In particular, an alkenylene dicarboxylic acid having 4 to 20 carbon atoms and an aromatic dicarboxylic acid having 8 to 20 carbon atoms are preferably used.

Specific examples of the tri- or more valent polycarboxylic acid include aromatic polycarboxylic acids having 9 to 20 carbon atoms such as trimellitic acid and pyromellitic acid. The polycarboxylic acid can be formed from a reaction between one or more of the polyols and an anhydride or lower alkyl ester of one or more of the above-mentioned acids. Suitable preferred lower alkyl esters include, but are not limited to, methyl esters, ethyl esters and isopropyl esters.

When the dicarboxylic acids and the tri- or more valent polycarboxylic acids are combined, the tri- or more polycarboxylic acids are preferably included in an amount of 0.01 to 10% by weight, and more preferably from 0.01 to 1% by weight. The polyols and the polycarboxylic acids are mixed such that an equivalent ratio of a hydroxyl group of the polyols to a carboxylic group of the polyols is typically from 1 to 2, preferably from 1 to 1.5, and more preferably from 1.02 to 1.3.

The polyester prepolymer having an isocyanate group preferably includes a polyol-originated structural unit in an amount 0.5 to 40% by weight, more preferably from 1 to 30% by weight, and most preferably from 2 to 20% by weight. When less than 0.5% by weight, the toner deteriorates in hot offset resistance, and is occasionally difficult to have both heat resistant preservability and low-temperature fixability. When greater than 40% by weight, the toner occasionally deteriorates in low-temperature fixability.

Specific examples of the polyisocyanate include aliphatic polyisocyanates such as tetramethylenediisocyanate, hexamethylenediisocyanate and 2,6-diisocyanatemethylcaproate; alicyclic polyisocyanates such as isophoronediisocyanate and cyclohexylmethanediisocyanate; aromatic diisocyanates such as tolylenedisocyanate, diphenylmethanediisocyanate, 1,5-naphthylenediisocyanate, 4,4′-diisocyanatediphenyl, 4,4′-diisocyanate-3,3′-dimethyldiphenyl, 4,4′-diisocyanate-3-methyldiphenylmethane and 4,4′-diisocyanate-diphenylether; aromatic aliphatic diisocyanates such as α,α,α′,α′-tetramethylxylylenediisocyanate; isocyanurates; the above-mentioned polyisocyanates blocked with phenol derivatives, oxime and caprolactam; and their combinations.

The polyisocyanate is mixed with the polyester resin having a hydroxyl group such that an equivalent ratio of an isocyanate group of the polyisocyanate to the hydroxyl group of the polyester resin is typically from 1 to 5, preferably from 1.2 to 4 and more preferably from 1.5 to 3. When greater than 5, low-temperature fixability of the resultant toner occasionally deteriorates. When less than 1, hot offset resistance of the resultant toner occasionally deteriorates.

The polyester prepolymer having an isocyanate group preferably includes a polyisocyanate-originated structural unit in an amount 0.5 to 40% by weight, more preferably from 1 to 30% by weight, and most preferably from 2 to 20% by weight. When less than 0.5% by weight, the toner deteriorates in hot offset resistance. When greater than 40% by weight, the toner occasionally deteriorates in low-temperature fixability.

The number of the isocyanate groups included in a molecule of the polyester prepolymer is at least 1, preferably from 1.2 to 3 on average, and more preferably from 1.5 to 4 on average. When less than 1, the molecular weight of the urea-modified polyester resin decreases and the toner deteriorates in hot offset resistance.

In the present invention, known binder resins such as polyester resins can be used, and an unmodified polyester resin is more preferably used, which improves low-temperature fixability and glossiness of the toner. The unmodified polyester resin includes a polycondensated product of polyol and polycarboxylic acid, and is preferably compatible with a urea-modified polyester resin partially, i.e., they preferably have structures compatible with each other in terms of low-temperature fixability and hot offset resistance.

The unmodified polyester resin preferably has a weight-average molecular weight of from 1,000 to 30,000, preferably from 1,500 to 10,000. When less than 1,000, the heat resistant preservability of the resultant toner deteriorates. Therefore, the content of components having a weight-average molecular weight less than 1,000 is preferably from 8 to 28% by weight. When greater than 30,000, the low-temperature fixability thereof occasionally deteriorates.

The unmodified polyester resin preferably has a glass transition temperature of from 30 to 70° C., more preferably from 35 to 60° C., and even more preferably from 35 to 50° C. When less than 30° C., the heat resistant preservability of the resultant toner occasionally deteriorates. When greater than 70° C., the low-temperature fixability thereof occasionally deteriorates.

The unmodified polyester resin preferably has a hydroxyl value not less than 5 KOH mg/g, more preferably from 10 to 120 KOH mg/g, and even more preferably from 20 to 80 KOH mg/g. When less than 5 KOH mg/g, the resultant toner is occasionally difficult to have both heat resistant preservability and low-temperature fixability.

The unmodified polyester resin preferably has an acid value of from 1.0 to 50.0 KOH mg/g, and more preferably from 1.0 to 30.0 KOH mg/g. The resultant toner is easy to be negatively charged.

When the toner includes the unmodified polyester resin, a weight ratio of the polyester prepolymer having an isocyanate group to the unmodified polyester resin is preferably from 5/95 to 25/75, and more preferably from 10/90 to 25/75. When less than 5/95, the hot offset resistance of the resultant toner occasionally deteriorates. When greater than 25/75, the low-temperature fixability thereof or glossiness of images produced thereby occasionally deteriorates.

The colorant is not particularly limited, and can be selected from known dyes and pigments in accordance with the purpose. Specific examples of the dyes and pigments include carbon black, Nigrosine dyes, black iron oxide, NAPHTHOL YELLOW S (C.I. 10316), HANSA YELLOW 10G (C.I. 11710), HANSA YELLOW 5G (C.I. 11660), HANSA YELLOW G (C.I. 11680), Cadmium Yellow, yellow iron oxide, loess, chrome yellow, Titan Yellow, polyazo yellow, Oil Yellow, HANSA YELLOW GR (C.I. 11730), HANSA YELLOW A (C.I. 11735), HANSA YELLOW RN (C.I. 11740), HANSA YELLOW R (C.I. 12710), PIGMENT YELLOW L (C.I. 12720), BENZIDINE YELLOW G (C.I. 21095), BENZIDINE YELLOW GR (C.I. 21100), PERMANENT YELLOW NCG (C.I. 20040), VULCAN FAST YELLOW 5G (C.I. 21220), VULCAN FAST YELLOW R(C.I. 21135), Tartrazine Lake, QUINOLINE YELLOW LAKE, ANTHRAZANE YELLOW BGL (C.I. 60520), isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, BRILLIANT CARMINE BS, PERMANENT RED F2R (C.I. 12310), PERMANENT RED F4R (C.I. 12335), PERMANENT RED FRL (C.I. 12440), PERMANENT RED FRLL (C.I. 12460), PERMANENT RED F4RH (C.I. 12420), Fast Scarlet VD, VULCAN FAST RUBINE B (C.I. 12320), BRILLIANT SCARLET G, LITHOL RUBINE GX (C.I. 12825), PERMANENT RED F5R, BRILLIANT CARMINE 6B, Pigment Scarlet 3B, Bordeaux 5B, Toluidine Maroon, PERMANENT BORDEAUX F2K (C.I. 12170), HELIO BORDEAUX BL (C.I. 14830), BORDEAUX 10B, BON MAROON LIGHT (C.I. 15825), BON MAROON MEDIUM (C.I. 15880), Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS (C.I. 69800), INDANTHRENE BLUE BC (C.I. 69825), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These can be used alone or in combination.

A toner preferably includes the colorant in an amount of from 1 to 15% by weight, and more preferably from 3 to 10% by weight of the toner. When less than 1% by weight, the resultant toner deteriorates in colorability. When greater than 15% by weight, the resultant toner deteriorates in colorability and has poor electrostatic properties due to defective dispersion of the colorant in the toner.

Masterbatches, which are complexes of a colorant with a resin, can be used as the colorant of the toner of the present invention. Specific examples of the resins for use as the binder resin of the master batches include polymers of styrene or styrene derivatives, styrene copolymers, polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These can be used alone or in combination.

The toner of the present invention may include a wax dispersant together with a binder resin (binder), a colorant and a release agent (wax). The wax dispersant improves dispersibility of the release agent in the binder resin, and the dispersibility thereof can easily be controlled by contents of the release agent and the wax dispersant. Further, the toner of the present invention includes a polyester resin in an amount of from 50 to 100% by weight, but which is scarcely compatible with the wax. Without the wax dispersant, the wax is not introduced into the toner and discharged in the aqueous medium occasionally. Further, the wax is released on the surface of the toner and increases thereon, resulting in contamination of other members. Therefore, the wax dispersant is preferably used.

Further, the wax dispersant preferably has a difference of from 1 to 10 mPa·S, and more preferably from 2 to 5 mPa·S between a melt viscosity at 100° C. and a melt viscosity at 160° C. The resultant toner both has low-temperature fixability and separability from a fixing roller, the reasons are not clarified, though. It is thought this is because bleeding out from the toner and adherence between a paper and a fixing member. The melt viscosity of the wax dispersant is measured by the same method of measuring the melt viscosity of the wax.

The wax dispersant preferably includes a molecular chain formed of a C—H bond and a C—C bond only. Further, the wax dispersant preferably includes the following resin (D) as a main chain and a graft polymer as a side chain, which is the following resin (E) having a grafted structure. Known resins capable of grafting the resin (E) can be used as the resin (D). Polyolefin resins, and more preferably heat-loss polyolefin resins are used. Olefins forming the polyolefin resins include ethylene, propylene, 1-butene, isobutylene, 1-hexene, 1-dodecene, 1-octadecene, etc. Polyolefin resins include olefin polymers, oxides of olefin polymers, modified olefin polymers, copolymers with other monomers copolymerizable with olefins, etc.

The olefin polymers include polyethylene, polypropylene, ethylene-propylene copolymers, ethylene-1-butene copolymers, propylene-1-hexene copolymers, etc. The oxides of olefin polymers include oxides of the above examples of the olefin polymers. The modified olefin polymers include maleic acid derivative (such as maleic anhydride, maleic monomethyl, maleic monobutyl and maleic dimethyl) adducts of the olefin polymers.

The copolymers with other monomers copolymerizable with olefins include copolymers with monomers, e.g., unsaturated carboxylic acids such as (meth)acrylic acid, itaconic acid and maleic anhydride; and unsaturated carboxylic alkyl ester such as (meth)acrylic alkyl (C1 to C18) ester and maleic alkyl (C1 to C18) ester with olefins.

In the present invention, the polymer structure has only to have a polyolefin structure, and the monomer does not necessarily has a polyolefin structure. Polymethylene such as sasol wax can also be used. The olefin polymers, the oxides of olefin polymers and the modified olefin polymers are preferably used. Polyethylene, polymethylene, polypropylene, ethylene-propylene copolymers, oxidized polyethylene, oxidized polypropylene and maleic polypropylene are more preferably used. Particularly, polyethylene and polypropylene are most preferably used.

Monomers forming the resin (E) include unsaturated carboxylic acid alkyl esters having 1 to 5 carbon atoms such as methyl(meth)acrylate, ethyl(meth)acrylate, butyl(meth)acrylate and 2-ethylhexyl(meth)acrylate; and vinylester monomers such as vinylacetate. Among these, alkyl methyl(meth)acrylate is preferably used, and alkyl methyl(meth)acrylate having 1 to 5 carbon atoms (E1) is more preferably used.

Aromatic vinyl monomers (E2) combined with the monomers (E1) forming the resin (E) include styrene monomers such as styrene, α-methylstyrene, p-methylstyrene, m-methylstyrene, p-methoxystyrene, p-hydroxystyrene, p-acetoxystyrene, vinyltoluene, ethylstyrene, phenylstyrene and benzylstyrene. Among these, styrene is preferably used.

A weight ratio of a resin (D) which is a main chain of the wax dispersant (D) to the resin (E) which is a side chain thereof is preferably from 1 to 50. When greater than 50, compatibility of the wax dispersant and the binder resin deteriorates. When less than 1, the wax dispersant is not fully compatible with the release agent and which is not fully dispersed in the toner. The toner of the present invention includes the wax dispersant in an amount of from 0.01 to 8 parts by weight, and more preferably from 0.5 to 6 parts by weight. This properly maintains an amount of the release agent present on the surface of the toner, particularly improves releasability of the toner from a fixing roller or belt, and further improves smear resistance of the toner.

The wax dispersant is preferably included in an amount of from 10 to 300% by weight per 100% by weight of the wax.

The was dispersant preferably has a glass transition temperature of from 55 to 80° C., and more preferably from 55 to 70° C. When greater than 80° C., the low-temperature fixability of the toner deteriorates. When less than 55° C., the hot offset resistance thereof deteriorates.

Whether at least a part of the wax is present as plural independent dispersed wax particles included in the toner or the dispersion status of the wax is observed by a TEM (transmission electron microscope).

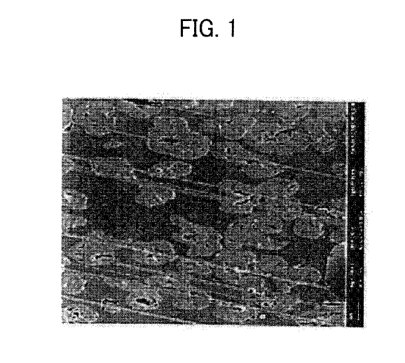

Specifically, a toner buried in an epoxy resin is ultra-thin sliced to have a thickness about 100 μm and dyed with ruthenium tetroxide to observe with a transmission electron microscope at 10,000 magnifications. FIG. 1 is a TEM picture of the toner of the present invention. The wax is dispersed at the surface of the toner and uniformly dispersed therein as well. The thus dispersed wax effectively improves hot offset resistance, and does not deteriorate chargeability, developability and anti-blocking of the toner even in a small amount.

It is preferable that the dispersed wax particles are uniformly dispersed in a toner. The uniform dispersion means plural dispersed wax particles are present in a toner without uneven distribution. For example, the dispersed wax particles in a range within 2/3 of a radius from the center of a toner to a random point on the outer circumference thereof in a random cross-section including the center of a toner is preferably greater than 30% and less than 60% by number based on total number of the wax on the cross-section. The wax preferably has an exposed area on the outermost surface of the toner not greater than 5% based on total outermost surface area thereof.

A toner material liquid includes at least the wax dispersed particles in an oily medium. The wax dispersed particles in the toner material liquid preferably has a volume-average particle diameter of from 0.1 to 2 μm, and more preferably from 0.1 to 1 μm. When less than 0.1 μm, the resultant toner occasionally does not have sufficient releasability. When greater than 2 μm, the wax in the toner occasionally deteriorate in uniform dispersibility. The volume-average particle diameter of the wax dispersed particles is controllable by an amount of the wax dispersant and the wax dispersion conditions. Increasing the wax dispersant or strengthening the dispersion conditions makes the dispersion particle diameter smaller.

The wax is preferably dispersed by a beads mill, and prolonging a dispersion time, increasing rotational numbers of the beads mill and making beads particle diameter smaller strengthen the dispersion conditions.

The beads mill preferably has a particle diameter of from 0.05 to 3 mm. When greater than 3 mm, the wax is not fully dispersed. When less than 0.05 mm, the beads are difficult to separate and the dispersion is difficult to maintain.

The toner of the present invention may include a charge controlling agent, a particulate resin, an inorganic particulate material, a fluidity improver, a cleanability improver, a magnetic material, a metal soap, etc. beside the above-mentioned materials.

The toner material liquid is an oily medium in which materials forming a toner are dissolved or dispersed. The materials forming a toner are not particularly limited, and include, e.g., any one of monomers, polymers, an active-hydrogen-group-containing compound, a polymer reactable with the active-hydrogen-group-containing compound (prepolymer), and at least a colorant and a wax, and other contents such as a wax dispersant and a charge controlling agent if necessary.

The toner material liquid is prepared by dissolving or dispersing the toner materials such as the active-hydrogen-group-containing compound, the polymer reactable with the active-hydrogen-group-containing compound, the wax, the colorant, the charge controlling agent, etc. in an oily medium. The materials besides the polymer reactable with the active-hydrogen-group-containing compound may be added to an aqueous medium or added thereto with the toner material liquid.

The oily medium is a solvent capable of dissolving or dispersing the toner materials, and preferably includes an organic solvent. The organic solvent is preferably removed when or after a particulate mother toner is prepared. The organic solvent preferably has a boiling point less than 150° C. in terms of removal easiness. When greater than 150° C., the toner occasionally agglutinates when the solvent is removed. Specific examples of the solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. Among these solvents, toluene, xylene, benzene, methylene chloride, 1,2-dichloroethane, chloroform, and carbon tetrachloride are preferably used, and ethylacetate is more preferably used. These solvents can be used alone or in combination. The content of the solvent is preferably from 40 to 300 parts by weight, more preferably from 60 to 140 parts by weight, and furthermore preferably from 80 to 120 parts by weight per 100 parts by weight of the toner materials.

Specific examples of the charge controlling agent include, but are not limited to, known charge controlling agents such as triphenylmethane dyes, chelate compounds of molybdic acid, Rhodamine dyes, alkoxyamines, quaternary ammonium salts including fluorine-modified quaternary ammonium salts, alkylamides, phosphor and compounds including phosphor, tungsten and compounds including tungsten, fluorine-containing surfactants, metal salts of salicylic acid and salicylic acid derivatives. These can be used alone or in combination. They are preferably colorless or white because the toner occasionally changes the color tone when they have colors.

Specific examples of the marketed products of the charge controlling agents include BONTRON P-51 (quaternary ammonium salt), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; quinacridone, azo pigments, and polymers having functions groups such as sulfone groups, carboxylic groups and quaternary ammonium salts.

The charge controlling agent may be dissolved or dispersed after melted and kneaded with a masterbatch, in a solvent with toner materials or fixed on the surface of a toner after prepared. The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10% by weight, and preferably from 0.2 to 5% by weight, per 100% by weight of the binder resin included in the toner. When less than 0.1% by weight, the toner occasionally does not have charge controllability. When greater than 10% by weight, the toner has too large charge quantity, and thereby the electrostatic force of a developing roller attracting the toner increases, resulting in occasional deterioration of the fluidity of the toner and decrease of the image density of toner images.

The particulate resin is not particularly limited so long as it is capable of forming an aqueous dispersion and can be selected from known resins. Specific examples thereof include any thermoplastic and thermosetting resins capable of forming a dispersion element such as vinyl resins, polyurethane resins, epoxy resins, polyester resins, polyamide resins, polyimide resins, silicon resins, phenol resins, melamine resins, urea resins, aniline resins, ionomer resins, polycarbonate resins, etc. Particularly, at least a resin selected from the group consisting of vinyl resins, polyurethane resins, epoxy resins and polyester resins is preferably used because the aqueous dispersion including microscopic spherical particulate resins is easy to prepare.

Specific examples of the vinyl resins include homopolymerized or copolymerized polymers such as styrene-(metha)esteracrylate resins, styrene-butadiene copolymers, (metha)acrylic acid-esteracrylate polymers, styrene-acrylonitrile copolymers, styrene-maleic acid anhydride copolymers and styrene-(metha)acrylic acid copolymers.

As the particulate resin, a copolymer including a monomer having at least two unsaturated groups can also be used. The monomer having at least two unsaturated groups is not particularly limited, and can be selected in accordance with the purpose. Specific examples thereof include a sodium salt of a sulfate ester with an additive of ethylene oxide methacrylate (ELEMINOL RS-30 from Sanyo Chemical Industries, Ltd.), divinylbenzene, 1,6-hexanediolacrylate, etc.

The particulate resin can be prepared by any known polymerization methods, however, preferably prepared in the form of an aqueous dispersion thereof. The aqueous dispersion thereof can be prepared by the following methods:

(1) a method of directly preparing an aqueous dispersion of a vinyl resin from a vinyl monomer by a suspension polymerization method, an emulsification polymerization method, a seed polymerization method or a dispersion polymerization method;

(2) a method of preparing an aqueous dispersion of polyaddition or polycondensation resins such as a polyester resin, a polyurethane resin and an epoxy resin by dispersing a precursor (such as a monomer and an oligomer) or a solution thereof in an aqueous medium under the presence of a dispersant to prepare a dispersion, and heating the dispersion or adding a hardener thereto to harden the dispersion;

(3) a method of preparing an aqueous dispersion of polyaddition or polycondensation resins such as a polyester resin, a polyurethane resin and an epoxy resin by dissolving an emulsifier in a precursor (such as a monomer and an oligomer) or a solution (preferably a liquid or may be liquefied by heat) thereof to prepare a solution, and adding water thereto to subject the solution to a phase-inversion emulsification;

(4) a method of pulverizing a resin prepared by any polymerization methods such as addition condensation, ring scission polymerization, polyaddition and condensation polymerization with a mechanical or a jet pulverizer to prepare a pulverized resin and classifying the pulverized resin to prepare a particulate resin, and dispersing the particulate resin in an aqueous medium under the presence of a dispersant;

(5) a method of spraying a resin solution wherein a resin prepared by any polymerization methods such as addition condensation, ring scission polymerization, polyaddition and condensation polymerization is dissolved in a solvent to prepare a particulate resin, and dispersing the particulate resin in an aqueous medium under the presence of a dispersant;

(6) a method of adding a lean solvent in a resin solution wherein a resin prepared by any polymerization methods such as addition condensation, ring scission polymerization, polyaddition and condensation polymerization is dissolved in a solvent, or cooling a resin solution wherein the resin is dissolved upon application of heat in a solvent to separate out a particulate resin and removing the solvent therefrom, and dispersing the particulate resin in an aqueous medium under the presence of a dispersant;

(7) a method of dispersing a resin solution, wherein a resin prepared by any polymerization methods such as addition condensation, ring scission polymerization, polyaddition and condensation polymerization is dissolved in a solvent, in an aqueous medium under the presence of a dispersant, and removing the solvent upon application of heat or depressure; and

(8) a method of dissolving an emulsifier in a resin solution wherein a resin prepared by any polymerization methods such as addition condensation, ring scission polymerization, polyaddition and condensation polymerization is dissolved in a solvent, and adding water thereto to subject the solution to a phase-inversion emulsification.

The inorganic particulate material is not particularly limited, and can be selected from known inorganic particulate materials. Specific examples thereof include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. These can be used alone or in combination. The inorganic particulate materials preferably have a primary particle diameter of from 5 nm to 2 μm, and more preferably from 5 nm to 500 nm. The inorganic particulate materials preferably have a specific surface area of from 20 to 500 m²/g when measured by BET method. The toner preferably includes the inorganic particulate material in an amount of from 0.01 to 5.0% by weight.

The inorganic particulate material is preferably surface-treated with a fluidity improver to improve hydrophobicity thereof and prevents deterioration of fluidity and chargeability thereof. Specific examples of the fluidity improver include silane coupling agents, sililating agents, silane coupling agents having an alkyl fluoride group, organic titanate coupling agents, aluminium coupling agents silicone oils and modified silicone oils.

The cleanability improver is used to easily remove a toner remaining on a photoreceptor and a first transferer after transferred. Specific examples thereof include fatty acid metallic salts such as zinc stearate, calcium stearate and stearic acid; and particulate polymers prepared by a soap-free emulsifying polymerization method such as particulate polymethylmethacrylate and particulate polystyrene. The particulate polymers comparatively have a narrow particle diameter distribution and preferably have a volume-average particle diameter of from 0.01 to 1 μm.

Specific examples of the magnetic material include iron powder, magnetite, ferrite, etc. The magnetic material is preferably white in color in terms of color tone of a toner.

The toner is prepared by emulsifying or dispersing an oil phase (a toner material liquid) including at least a binder resin, a colorant and a wax in an aqueous medium including a surfactant. Methods of forming parent toner particles while producing an adhesive base material include preparing an aqueous medium, preparing a liquid including toner materials, emulsifying or dispersing the toner materials, producing the adhesive base material, removing a solvent, synthesizing a polymer having reactivity with an active hydrogen, synthesizing a compound having an active hydrogen, etc.

The aqueous medium can be prepared by dispersing a particulate resin therein. The aqueous medium preferably includes the particulate resin dispersed therein in an amount of from 0.5 to 10% by weight.

The liquid including toner materials is prepared by dissolving or dispersing toner materials such as a compound having an active hydrogen, a polymer having reactivity with an active hydrogen, a rheology additive, a colorant, a release agent, a charge controlling agent and an unmodified polyester resin in a solvent.

The toner materials besides the polymer reactable with the compound having a group including an active hydrogen may be added the aqueous medium when the particulate resin is dispersed therein or when the solution or dispersion of the toner materials is added to the aqueous medium.

When the solution or dispersion of the toner materials is emulsified or dispersed in the aqueous medium, the compound having a group including an active hydrogen and the polymer reactable therewith are subjected to an elongation or crosslinking reaction to produce the adhesive base material.

The adhesive base material such as urea-modified polyester resins may be produced by emulsifying or dispersing the solution or dispersion of the toner materials including the polymer reactable with the compound having a group including an active hydrogen such as the prepolymer including an isocyanate group with the compound having a group including an active hydrogen such as the amines in the aqueous medium to be subjected to an elongation or a crosslinking reaction; emulsifying or dispersing the solution or dispersion of the toner materials in the aqueous medium previously including the compound having a group including an active hydrogen to be subjected to an elongation or a crosslinking reaction; or emulsifying or dispersing the solution or dispersion of the toner materials in the aqueous medium, and adding the compound having a group including an active hydrogen thereto to be subjected to an elongation or a crosslinking reaction, wherein the modified polyester is preferentially formed on the surface of the toner, which can have a concentration gradient thereof.

The reaction time of the elongation or crosslinking reaction between the compound having a group including an active hydrogen and the polymer reactable therewith is preferably from 10 min to 40 hrs, and more preferably from 2 to 24 hrs. The reaction temperature is preferably from 0 to 150° C., and more preferably from 40 to 98° C.

Methods of stably forming the dispersion including the polymer reactable with the compound having a group including an active hydrogen, such as the polyester prepolymer including an isocyanate group in the aqueous medium include, e.g., a method of adding the solution or dispersion prepared by dissolving or dispersing the polymer reactable with the compound having a group including an active hydrogen such as the polyester prepolymer including an isocyanate group, the colorant, the release agent, the charge controlling agent and the unmodified polyester resin in the organic solvent, into the aqueous medium, and dispersing the solution or dispersion therein with a shearing force.

The dispersion method is not particularly limited, and known mixers and dispersers such as a low shearing-force disperser, a high shearing-force disperser, a friction disperser, a high-pressure jet disperser and an ultrasonic disperser can be used. In order to prepare the toner for use in the present invention, it is preferable to prepare an emulsion including particles having an average particle diameter of from 2 to 20 μm. Therefore, the high shearing-force disperser is preferably used. When the high shearing-force disperser is used, the rotation speed of rotors thereof is not particularly limited, but the rotation speed is typically from 1,000 to 30,000 rpm, and preferably from 5,000 to 20,000 rpm. In addition, the dispersion time is also not particularly limited, but the dispersion time is typically from 0.1 to 5 minutes. The temperature in the dispersion process is typically 0 to 150° C. (under pressure), and preferably from 40 to 98° C. The processing temperature is preferably as high as possible because the viscosity of the dispersion decreases and thereby the dispersing operation can be easily performed.

The content of the aqueous medium to 100 parts by weight of the toner material liquid is typically from 50 to 2,000 parts by weight, and preferably from 100 to 1,000 parts by weight. When the content is less than 50 parts by weight, the dispersion of the toner materials in the aqueous medium is not satisfactory, and thereby the resultant mother toner particles do not have a desired particle diameter. In contrast, when the content is greater than 2,000, the production cost increases.

Before the toner materials solution or dispersion is dispersed in the aqueous medium, a dispersant is preferably dispersed therein because the toner materials solution or dispersion is stably dispersed therein and the resultant toner has a sharp particle diameter distribution. Specific examples of the dispersant include a surfactant, an inorganic dispersant hardly soluble in water, a polymer protective colloid, etc. These can be used alone or in combination, and the surfactant is preferably used.

The surfactants include anionic surfactants, cationic surfactants, nonionic surfactants, ampholytic surfactants, etc.

Specific examples of the anionic surfactants include an alkylbenzene sulfonic acid salt, an α-olefin sulfonic acid salt, a phosphoric acid salt, etc., and anionic surfactants having a fluoroalkyl group are preferably used.

Specific examples thereof include fluoroalkyl carboxylic acids having from 2 to 10 carbon atoms and their metal salts, disodium perfluorooctanesulfonylglutamate, sodium 3-{ω-fluoroalkyl(C6-C11)oxy}-1-alkyl(C3-C4) sulfonate, sodium 3-{ω-fluoroalkanoyl (C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl (C6-C10)-N-ethylsulfonyl glycin, monoperfluoroalkyl(C6-C16)ethylphosphates, etc.

Specific examples of the marketed products of such surfactants include SARFRON S-111, S-112 and S-113, which are manufactured by Asahi Glass Co., Ltd.; FLUORAD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants include amine salts such as an alkyl amine salt, an aminoalcohol fatty acid derivative, a polyamine fatty acid derivative and an imidazoline; and quaternary ammonium salts such as an alkyltrimethyl ammonium salt, a dialkyldimethyl ammonium salt, an alkyldimethyl benzyl ammonium salt, a pyridinium salt, an alkyl isoquinolinium salt and a benzethonium chloride. Among the cationic surfactants, primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc. are preferably used.

Specific examples of the marketed products thereof include SARFRON S-121 (from Asahi Glass Co., Ltd.); FLUORAD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Specific examples of the nonionic surfactants include a fatty acid amide derivative, a polyhydric alcohol derivative, etc. Specific examples of the ampholytic surfactants include alanine, dodecyldi(aminoethyl)glycin, di(octylaminoethyle)glycin, and N-alkyl-N,N-dimethylammonium betaine, etc.

Specific examples of the inorganic surfactants hardly soluble in water include tricalcium phosphate, calcium carbonate, colloidal titanium oxide, colloidal silica, and hydroxyapatite.

Specific examples of the protective colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethylacrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

In addition to the dispersants, a dispersion stabilizer may be used when necessary. Specific examples thereof include acid and alkali-soluble materials such as calcium phosphate. It is preferable to dissolve the dispersant with hydrochloric acid to remove that from the toner particles, followed by washing. In addition, it is possible to remove such a dispersant by decomposing the dispersant using an enzyme.

In addition, known catalysts such as dibutyltin laurate and dioctyltin laurate can be used for the elongation and crosslinking reaction, if desired.

The organic solvent is removed from the dispersion (emulsified slurry) by a method of gradually heating the dispersion to completely evaporate the organic solvent in the oil drop or a method of spraying the emulsified dispersion in a dry atmosphere to completely evaporate the organic solvent in the oil drop and to evaporate the aqueous dispersant, etc. When removed, mother toner particles are formed. The mother toner particles are washed, dried and further classified if desired. The mother toner particles are classified by removing fine particles with a cyclone, a decanter, a centrifugal separator, etc. in the dispersion. Alternatively, the mother toner particles may be classified as a powder after dried. The thus prepared dry mother toner particles can be mixed with one or more other particulate materials such as external additives mentioned above, release agents, charge controlling agents, fluidizers and colorants optionally upon application of mechanical impact thereto to fix the particulate materials on the mother toner particles.

Specific examples of such mechanical impact application methods include methods in which a mixture is mixed with a highly rotated blade and methods in which a mixture is put into a jet air to collide the particles against each other or a collision plate. Specific examples of such mechanical impact applicators include ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTRON SYSTEM (manufactured by Kawasaki Heavy Industries, Ltd.), automatic mortars, etc.

In the present invention, surface-treated particles before an external additive is added thereto are referred to as “mother toner” and particles before their surface are treated are referred to as “colored particles”.

The present inventors have been disclosing a number of methods of preparing mother toner particles by emulsifying and dispersing an organic solvent including toner materials such as a crosslinking reactable low-molecular weight binder resin and a colorant in an aqueous dispersion in the form of a liquid drop to prepare an O/W dispersion, and removing the solvent therefrom.

The aqueous dispersion includes many aqueous dispersions in which a microscopic inorganic and/or a particulate resin are dispersed. In addition, some methods of preparing toner, including a process of maturing mother toner particles (surface treatment process), a process of washing the mother toner particles to remove a surfactant originated from the O/W emulsion dispersion, and a process of treating the mother toner particles with a surfactant are also included, regardless of the order of these processes.

Decreasing the content of the surfactant in maturing the mother toner particles controls production of microscopic concavities and convexities, and which exerts a good effect on the surface smoothness. This is applicable not only to other methods of preparing chemical toners but also to methods of pulverization toners.

Namely, in the present invention, the emulsification or dispersion process is followed by a surface treatment process, and a surfactant used in the surface treatment process preferably has a concentration of from 0.1 to less than 2.0 times of a critical micellar concentration thereof.

The critical micellar concentration of the surfactant in the aqueous medium can be determined by surface tension methods, electroconductivity methods, dye methods, etc.

The surfactant is dropped by 0.01% by weight in an aqueous medium and a surface tension is measured by a surface tensiometer Sigma from KSV Instruments Ltd. after stirred and left, using an analysis program in Sigma system. From the surface tension curve obtained, a concentration of the surfactant at which the surface tension does not lower even when the surfactant is dropped is determined as the critical micellar concentration.

A concentration of the surfactant in a toner dispersion liquid can be measured by dropping the surfactant therein by 0.01% by weight in an aqueous medium. Then, the electroconductivity of the toner dispersion liquid is measured to prepare a standard curve, and a concentration of the surfactant in the toner dispersion can be determined.

The toner is preferably heated at a temperature close to a glass transition temperature thereof in water including a small amount of a surfactant. The binder resin in the toner slightly softens and fluidizes in a microscopic area so as to make the surface area smaller, and microscopic convexities and concavities having a size of from some nm to some hundred nm present on the mother toner are smoothed.

However, when the toner is simply heated, contamination of other members of the toner, particularly of a carrier occasionally worsens. Resins in the toner slightly softens and low-molecular-weight resins are exposed on the surface of the toner, contamination of other members, particularly of a carrier is assumed to worsen. Not only simply heating the toner but also applying a shearing force thereto when heated decrease contamination of other members. Further, applying a shearing force to a toner when heated can prevent the toner from agglutinating.

It is preferable that a shearing force is continuously applied while heating in terms of productivity, and PIPELINE HOMO MIXER from PRIMIX Corp. and Ebara Milder from EBARA Corp.

High-speed shearing mixers are preferably used as a shearing force applier. Specific examples thereof include POLYTRON homogenizer from Central Scientific Commerce, Inc., Physcotron homogenizer from Microtec Co., Ltd., Biomixer from NISSEI Corp., Turbo Mixer from Kodaira Seisakusho Co., Ltd., ULTRADISPER from ASADA IRON WORKS CO., LTD., Ebara Milder from EBARA Corp., TK HOMO MIXER, TK LABO DISPER, TK PIPELINE MIXER, TK HOMOMICLINE MILL, TK HOMO JETTER, TK UNIMIXER, TK HOMOMICLINE FLOW, and TK AGI HOMO MIXER from PRIMIX Corp, etc. These can be used alone or in combination.

When a toner receives a mechanical stress when stirred in an image developer, an external additive typically enters microscopic concavities and convexities on the surface of the toner to increase its non-electrostatic adherence and decrease its transferability. Particularly, a toner having a small particle diameter increases in its non-electrostatic adherence to a photoreceptor or an intermediate transferer, resulting in more deterioration of transferability of the toner. Further, when the toner having a small particle diameter is used in a high-speed machine, in addition to the increased adherence to an intermediate transferer due to the small particle diameter, the toner receives a transfer electric field for shorter time at transfer nips, particularly at a second transfer nip, resulting in known noticeable deterioration of transferability of the toner when secondly transferred.

As a heating method, in consideration of the colored particles dispersed in water, a cake including water in an amount of from 50 to 85% by weight is preferably placed in ion-exchanged water having a temperature of from 50 to 98° C. Thus, the colored particles have a preferred temperature and less microscopic concavities and convexities in a short time, and it can prevent a wax included in the colored particles from being exposed.

The thus prepared toner has smoothed microscopic concavities and convexities by the surface treatment to prevent the external additive from entering the concavities and convexities. In addition, even when the toner receives a mechanical stress, increase of the non-electrostatic adherence can be prevented and the toner has high transferability. In addition, a substantial coverage of a specific amount of an external additive becomes larger because the microscopic concavities and convexities on the surface of the toner are smoothed. Therefore, the external additive increases an effect of reducing the non-electrostatic adherence.

When a toner is heated in a gaseous phase, the toner particles are more likely to melt and adhere to each other than in water even at the same temperature, resulting in occasional deterioration of particle diameter distribution of the toner. In addition, a toner needs to be heated at higher temperature in a gaseous phase than in water, the toner particles melt and adhere to each other further. Therefore, a toner is preferably heated in water. When a surfactant included in the eater has a concentration higher than 2 times of its critical micellar concentration, the surfactant protects the microscopic concavities and convexities on the surface of the toner and do not smooth them, resulting in low transferability of the toner. When less than 0.1 times, not only concavities and convexities having a size of from some nm to some hundred nm, but also those having a size of some μm are smoothed, resulting in deterioration of cleanability of the toner. In addition, the toner particles are likely to melt and adhere to each other when heated in a surface treatment process, resulting in occasional deterioration of particle diameter distribution of the toner.

The toner of the present invention is obtained by modifying a toner material including at least a binder resin, a wax and a colorant in an aqueous medium including a surfactant, and a process of removing the surfactant is preferably included. The toner material of the toner obtained in an aqueous medium has affinity with water which is a dispersion solvent, and the surface of the toner can be smoothed more easily. The process of preparing a toner includes dispersing the toner in an aqueous medium and removing the surfactant therefrom, and increase due to a surface treatment process can be prevented.

Binder resins for use in the present invention preferably include a polyester resin as mentioned above. The polyester resin can improve antistress of the toner because of having better antishock than other resins even when having a low softening point to improve low-temperature fixability of the toner. In addition, the polyester resin has a hydrophilic group in its molecular structure and comparatively a high polarity, and the toner has good affinity with an aqueous medium and the surface thereof can more easily be smoothed.

The toner of the present invention can be used in various fields, and can preferably be used for electrophotographic image formation.

The toner of the present invention preferably has a volume-average particle diameter of from 1 to 8 μm, more preferably from 3 to 8 μm, and most preferably from 4 to 7 μm. When less than 1 μm, the toner is fusion-bonded to the surface of a carrier when used in a two-component developer, resulting in deterioration of the chargeability of the carrier, and filming thereof over a developing roller and fusion bond thereof to a blade forming a thin layer thereof are liable to occur when used as a one-component developer. Further, the toner is likely to scatter when firstly and secondly transferred. When greater than 8 μm, the toner is difficult to produce high definition and high-quality images, and largely varies in the particle diameter when the toner is consumed and fed in the developer. Further, the resultant image has insufficient dot reproducibility, and granularity of halftone images deteriorates and high-definition images cannot be produced.

The toner of the present invention preferably has a ratio (Dv/Dn) of the volume-average particle diameter (Dv) to a number-average particle diameter (Dn) of from 1.00 to 1.25, and more preferably from 1.05 to 1.25. Such a toner, when used in a two-component developer, has less variation of its particle diameter in the developer even after the toner is consumed and fed for long periods, and has good and stable developability even after stirred in an image developer for long periods. When greater than 1.25, the toner is difficult to produce high definition and high-quality images, and largely varies in the particle diameter when the toner is consumed and fed in the developer.

The volume-average particle diameter and a ratio of the volume-average particle diameter to a number-average particle diameter are measured by Multisizer III from Beckman Coulter, Inc. as follows:

0.1 to 5 ml of a detergent, preferably alkylbenzene sulfonate is included as a dispersant in 100 to 150 ml of the electrolyte ISOTON-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution.

The volume-average particle diameter and the number-average particle diameter of the toner can be determined from the distribution.

The toner preferably has a penetration not less than 15 mm, and more preferably from 20 to 30 mm when measured by the method specified in JIS K2235-1991. When less than 15 mm, the resultant toner has poor heat resistant preservability. Specifically, a glass container having a capacity of 50 ml is filled with a toner, and the glass container is left in a constant-temperature bath at 50° C. Then, the toner is cooled to have a room temperature and a penetration test is performed.

The toner of the present invention preferably has a low minimum fixable temperature and a high temperature at which offset does not occur in terms of having both low-temperature fixability and offset resistance. Therefore, it is preferable that the minimum fixable temperature is preferably less than 120° C. and the temperature at which the offset does not occur is not less than 191° C. The minimum fixable temperature is a temperature of a fixing roller in an image forming apparatus producing images having an image density not less than 70% after scraped with a pad. The temperature at which the offset does not occur can be measured using an image forming apparatus wherein an image is developed with a predetermined amount of the toner and a fixer can have a variable temperature.

Toner heat properties are, in other words, flow tester properties, and include a softening point, a flow starting temperature, a 1/2 softening point, etc. The heat properties can be measured by a method optionally selected, such as a flow curve using an elevated flow tester CFT500 from Shimadzu Corporation. The softening point is preferably not less than 30° C., and more preferably from 50 to 90° C. When less than 30° C., the resultant toner occasionally has poor heat resistant preservability.

The flow starting temperature is preferably not less than 60° C., and more preferably from 80 to 120° C. When less than 60° C., the resultant toner occasionally has poor heat resistant preservability or offset resistance.

The 1/2 softening point is preferably not less than 90° C., and more preferably from 100 to 170° C. When less than 90° C., the resultant toner occasionally has poor offset resistance.

The toner of the present invention preferably has a glass transition temperature of from 40 to 70° C., and more preferably from 45 to 65° C. When not less than 40° C., the toner has good heat resistant preservability. When greater than 70° C., the low-temperature fixability of the toner occasionally deteriorates. The glass transition temperature can be measured by a differential scanning calorimeter DSC-60 from Shimadzu Corp., etc.

Images formed by the toner of the present invention preferably has an image density measured by a spectrometer SPECTRODENSITOMETER 938 from X-Rite is preferably not less than 1.40, more preferably not less than 1.45, and even more preferably not less than 1.50. A high-quality image has an image density not less than 1.40. For example, imagio Neo 450 from Ricoh Company, Ltd. forms a solid image with a developer in an amount of 0.35±0.02 mg/cm² on a copy paper TYPE6200 from Ricoh Company, Ltd. at a surface temperature of 160±2° C. of the fixing roller, and an average of image density of random 5 parts of the solid image, measured by the spectrometer, is determined as the image density.

Colors of the toner of the present invention are not particularly limited, and can be selected from at least one of black, cyan, magenta and yellow.

The toner of the present invention preferably has an average circularity not less than 0.940 and less than 0.975. When not less than 0.975, the toner is close to a sphere and occasionally deteriorates in cleanability when removed from a photoreceptor and an intermediate transferer after transferred. When less than 0.940, the surface of the toner has many concavities and convexities having a size of from some hundred nm, and the toner occasionally does not have high transferability even when the surface thereof is smoothed.

The circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

The developer of the present invention includes at least the toner of the present invention, and optionally other components such as a carrier. The developer may be a one-component developer or a two-component developer, however, the two-component developer having a long life is preferably used in high-speed printers in compliance with the recent high information processing speed.

Even the one-component developer or two-component developer of the present invention has less variation of particle diameter of the toner even after repeatedly used, good and stable developability and produces quality images for long periods without filming over a developing roller and fusion bonding to a member such as a blade forming a thin layer of the toner.

The carrier is not particularly limited, and can be selected in accordance with the purpose, however, preferably includes a core material and a resin layer coating the core material.

The core material is not particularly limited, and can be selected from known materials such as Mn—Sr materials and Mn—Mg materials having 50 to 90 emu/g; and highly magnetized materials such as iron powders having not less than 100 emu/g and magnetite having 75 to 120 emu/g for image density. In addition, light magnetized materials such as Cu—Zn materials having 30 to 80 emu/g are preferably used to decrease a stress to a photoreceptor having toner ears for high-quality images. These can be used alone or in combination.

The core material preferably has a volume-average particle diameter of from 10 to 150 μm, and more preferably from 40 to 100 μm. When less than 10 μm, a magnetization per particle is so low that the carrier scatters. When larger than 150 μm, a specific surface area lowers and the toner occasionally scatters, and a solid image of a full-color image occasionally has poor reproducibility.

The resin coating the core material is not particularly limited, and can be selected in accordance with the purpose. Specific examples of the resin include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. These can be used alone or in combination.

Specific examples of the amino resins include urea-formaldehyde resins, melamine resins, benzoguanamine resins, urea resins, polyamide resins, epoxy resins, etc. Specific examples of the polyvinyl resins include acrylic resins, polymethylmethacrylate resins, polyacrylonitirile resins, polyvinyl acetate resins, polyvinyl alcohol resins, polyvinyl butyral resins, etc. Specific examples of the polystyrene resins include polystyrene resins, styrene-acrylic copolymers, etc. Specific examples of the halogenated olefin resins include polyvinyl chloride resins, etc. Specific examples of the polyester resins include polyethyleneterephthalate resins, polybutyleneterephthalate resins, etc.

An electroconductive powder may optionally be included in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The resin layer can be formed by preparing a coating liquid including a solvent and, e.g., the silicone resin; uniformly coating the liquid on the surface of the core material by a known coating method; and drying the liquid and burning the surface thereof. The coating method includes dip coating methods, spray coating methods, brush coating method, etc.

Specific examples of the solvent include, but are not limited to, toluene, xylene, methyl ethyl ketone, methyl isobutyl ketone, cellosolve butyl acetate, etc. Specific examples of the burning methods include, but are not limited to, externally heating methods or internally heating methods using fixed electric ovens, fluidized electric ovens, rotary electric ovens, burner ovens, microwaves, etc.

The carrier preferably includes the resin layer in an amount of from 0.01 to 5.0% by weight. When less than 0.01% by weight, a uniform resin layer cannot be formed on the core material. When greater than 5.0% by weight, the resin layer becomes so thick that carrier particles granulate one another and uniform carrier particles cannot be formed.

The content of the carrier in a two-component developer is not particularly limited, can be selected in accordance with the purpose, and is preferably from 90 to 98% by weight, and more preferably from 93 to 97% by weight.

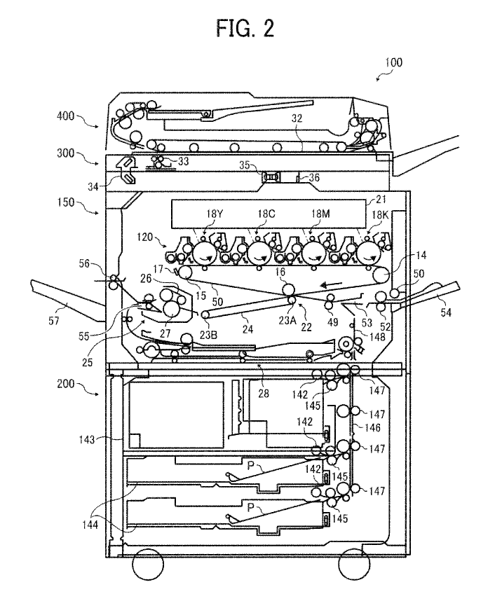

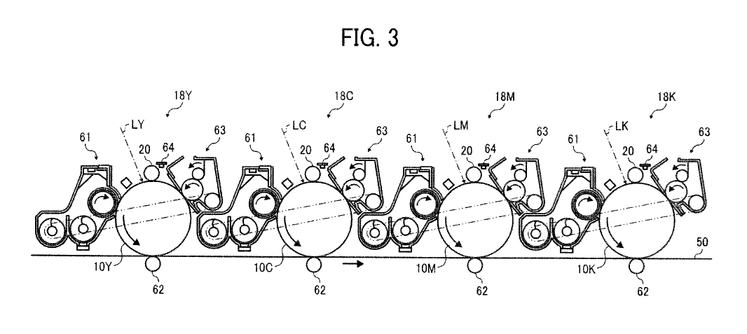

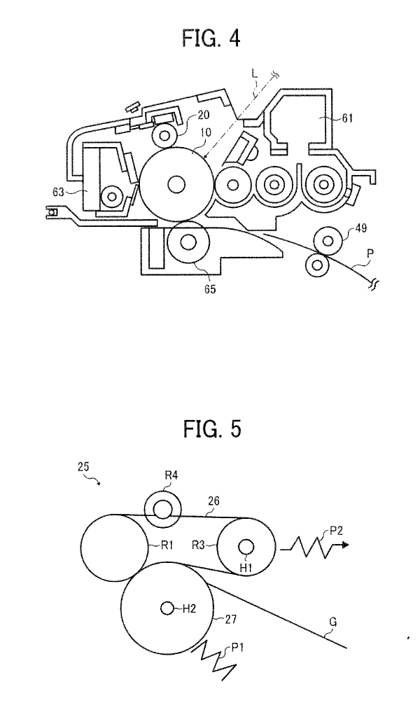

The developer of the present invention can be used known electrophotographic image forming methods such as magnetic one-component developing methods, non-magnetic one-component developing methods and two-component developing methods. Next, an embodiment of the image forming apparatus of the present invention will be explained, based on FIGS. 2, 3 and 4. FIG. 2 is a schematic view illustrating an embodiment of the image forming apparatus of the present invention. FIG. 3 is a schematic view illustrating an image forming means of the image forming apparatus in FIG. 2. FIG. 4 is a schematic view illustrating an embodiment of the process cartridge of the present invention.

The image forming apparatus in FIG. 2 is a tandem color image forming apparatus including a duplicator 150, a paper feeding table 200, a scanner 300 and an automatic document feeder (ADF) 400.

The duplicator 150 includes an intermediate transferer 50 having the shape of an endless belt. The intermediate transferer 50 is suspended by three suspension rollers 14, 15 and 16 and rotatable in a clockwise direction. On the left of the suspension roller 15, an intermediate transferer cleaner 17 is located to remove a residual toner on an intermediate transferer 50 after an image is transferred. Above the intermediate transferer 50, four image forming units 18 for yellow, cyan, magenta and black colors are located in line from left to right along a transport direction of the intermediate transferer 50 to form image forming means 120. Adjacent to the image forming means 120, an irradiator 21 is located. On the opposite side of the image forming means 120 across the intermediate transferer 50, a second transferer 22 is located.

The second transferer 22 includes a an endless second transfer belt 24 and a pair of support rollers 23A and 23B suspending the endless second transfer belt 24, and a recording paper P fed on the second transfer belt 24 and the intermediate transferer 50 can contact each other. Beside the second transferer 22, a fixer 25 is located. The fixer 25 includes an endless belt 26 and a pressure roller 27 pressed against the belt. Adjacent to the second transferer 22 and the fixer 25, a reverser 28 reversing the recording paper P to form an image on both sides thereof is located.

An original is set on a table of the ADF 400 to make a copy, or on a contact glass 32 of the scanner 300 and pressed with the ADF 400.

When a start switch (not shown) is put on, a first scanner 33 and a second scanner 34 scans the original after the original set on the table 130 of the ADF 400 is fed onto the contact glass 32 of the scanner 300, or immediately when the original set thereon. The first scanner 33 emits light to the original and reflects reflected light therefrom to the second scanner 34. The second scanner further reflects the reflected light to a reading sensor 36 through an imaging lens 35 to read the color original (color image) as image information of black, yellow, magenta and cyan. The black, yellow, magenta and cyan image information are transmitted to image forming units 18Y, 18C, 18M and 18K, respectively and the respective image forming units form a black toner image, a yellow toner image, a magenta toner image and a cyan toner image.

As FIG. 3 shows, the image forming units 18Y, 18C, 18M and 18K respectively have drum-shaped photoreceptors 10Y, 10C, 10M and 10K, chargers 20 uniformly charging the photoreceptors 10Y, 10C, 10M and 10K, irradiators 21 irradiating the photoreceptors 10Y, 10C, 10M and 10K based on each color image information to from electrostatic latent images thereon, image developers 61Y, 61C, 61M and 61K developing the electrostatic latent images with each color toner (black, yellow, magenta and cyan toner) to form each visual color toner image, first transfer chargers 62 to transfer the toner images onto an intermediate transferer 50, cleaners 63 and dischargers 64. Each of the visual color toner images is sequentially (first) transferred from the photoreceptors 10Y, 10C, 10M and 10K onto the intermediate transferer 50 rotated by support rollers 14, 15 and 16 to form a complex color toner image thereon.

On the other hand, one of paper feeding rollers 142 of paper feeding table 200 is selectively rotated to take a recording paper P out of one of multiple-stage paper cassettes 144 in a paper bank 143. A separation roller 145 separates the recording paper P one by one and feed the paper into a paper feeding route 146, and a feeding roller 147 feeds the paper into a paper feeding route 148 to be stopped against a registration roller 49. Alternatively, a paper feeding roller 142 is rotated to take a recoding paper out of a manual feeding tray 51, and a separation roller 52 separates the papers one by one and feed the paper into a paper feeding route 53 to be stopped against the registration roller 49. The registration roller 49 is typically earthed, and may be biased to remove a paper dust from the recording paper P. Then, in timing with the complex toner image on the intermediate transferer 50, the registration roller 49 is rotated to feed the recoding paper P between the intermediate transferer 50 and the second transferer 22, and the second transferer 22 transfers (second transfer) the complex toner image onto the recording paper. The toner remaining on the intermediate transferer 50 is removed by the cleaner 17.

The recording paper the complex toner image is transferred on is fed by the second transferer 22 to the fixer 25. The fixer 25 fixes the image thereon upon application of heat and pressure, and the sheet is discharged by a discharge roller 56 onto a catch tray 57 through a switch-over click 55. Alternatively, the switch-over click 55 feeds the sheet into the sheet reverser 28 reversing the sheet to a transfer position again to form an image on the backside of the sheet, and then the sheet is discharged by the discharge roller 56 onto the catch tray 57.

The image forming apparatus of the present invention using a toner having good low-temperature fixability and heat-resistant preservability even when images are produced at high speed and being fixable on a desirable position of a recording medium without offset phenomena, can stably fix images without production of abnormal images even at high process linear speed. Further, the tandem full-color image forming apparatus as mentioned above can produce high-quality images at high speed. The image forming apparatus of the present invention can widely be used in electrophotographic application fields such as electrostatic copiers and laser beam printers. The tandem full-color image forming apparatus can produce full-color images at high speed because of being capable of transfer plural toner images at a time.

The image forming means 120 may be installed in copiers, facsimiles and printers, and may be installed as a form of a process cartridge.

The process cartridge is a device (component) including an electrostatic latent image bearer (photoreceptor) and at least one of a charger, an irradiator, an image developer, a transferer and a cleaner. The process cartridge of the present invention includes a drum-shaped photoreceptor as an electrostatic latent image bearer and at least an image developer in a body, which is detachable from image forming apparatus and can be maintained, inspected and exchanged with ease. In other words, the process cartridge of the present invention includes at least an electrostatic latent image bearer and an image developer developing an electrostatic latent image borne thereon with a developer formed of a toner or a toner and a carrier to form a visual image, and optionally a charger, an irradiator, a transferer, a cleaner and a discharger.

An embodiment of the process cartridge of the present invention will be explained, referring to FIG. 4.

As FIG. 4 shows, the process cartridge of the present invention is a process cartridge including a drum-shaped photoreceptor 10 as an electrostatic latent image bearer, a charging roller 20 as a charger uniformly charging the surface of the photoreceptor 10, an image developer 61 providing a toner to an electrostatic latent image formed on the charged surface of the photoreceptor 10 by an irradiator 21 with light L to form a toner image and a cleaner 63 removing the toner remaining on the surface of the photoreceptor 10 after a transferer 65 transfers the toner image formed thereon onto a recording material P in a body, which is detachable from image forming apparatus. The process cartridge does not have to include all of the charging roller 20, the image developer 61 and the cleaner 63 with the photoreceptor 10. The process cartridge has only to include at least the image developer 61 therewith. The image developer 61 contains the toner of the present invention. Therefore, offset phenomena do not occur in the fixer 25 (FIG. 2), toner images are stably fixed only on desired positions of the recording paper P, and high-quality images are produced. In addition, the process cartridge is easy to store, transport and handle.

The toner of the present invention is filled in a cylindrical or a bag-shaped container capable of providing the toner in the image developer when necessary.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Measurement of Weight-Average Molecular Weight of Resin

Measurer: GPC-8220GPC from Tosoh Corp.

Column: TSKgel SuperHZM-H 15 cm Triple from Tosoh Corp.

Temperature: 40° C.

Solvent: THF

Flow Raete: 0.35 ml/min

Sample: 0.4 ml of 0.15% sample

Pretreatment of Sample: a toner was dissolved in THF including a stabilizer from Wako Pure Chemical Industries, Ltd. to have a concentration of 0.15%, and the solution was filtered with a 0.2 μm filter to use 100 μl of the filtered liquid as a sample.

When measuring a molecular weight of the sample, a molecular weight distribution of the sample was determined from a relation between a logarithmic value of a calibration curve prepared from several monodispersion polystyrene standard samples and a counter number.

As the polystyrene standard samples for preparing the calibration curve, Showdex STANDARD Std. No. S-7300, S-210, S-390, S-875, S-1980, S-10.9, S-629, S-3.0 and S-0.580 and toluene were used.

An RI (refraction index) detector was used as a detector.

### <Measurement of Volume-Average (Dv), Number-Average (Dn) Particle Diameters and Dv/Dn of Toner>

The volume-average particle diameter (Dv), the number-average particle diameter (Dn) and a ratio of the volume-average particle diameter to the number-average particle diameter are measured by Multisizer III from Beckman Coulter, Inc. with an aperture diameter of 100 μm. An analysis software (Beckman Coulter Multisizer 3 version 3.51) was used. Specifically, 0.1 to 0.5 g of the toner and 0.5 ml of a surfactant (alkylbenzenesulfonate Neogen SC-A from Dai-ichi Kogyo Seiyaku Co., Ltd.) having a concentration of 10% by weight were mixed by a micro spatel in a glass beaker having a capacity of 100 ml, and 80 ml of ion-exchange water was added to the mixture. The mixture was dispersed by an ultrasonic disperser W-113MK-II from HONDA ELECTRONICS CO., LTD. for 10 min. The dispersion was measure by Multisizer III using ISOTON III as a measurement solution from Beckman Coulter, Inc. The dispersion was dropped such that Multisizer III displays a concentration of 8±12%, which is essential in terms of measurement reproducibility of the particle diameter. The measurement of the particle diameter has no error within this concentration range.

### <Measurement of Glass Transition Temperature and Melting Point>

In the present invention, a glass transition temperature (Tg) and a melting point are specifically determined by TA-60WS and DSC-60 from Shimadzu Corp. under the following conditions.

Sample container: Sample pan made of aluminum (with a lid)

Sample amount: 5 mg

Reference: Sample pan made of aluminum (10 mg of alumina)

Atmosphere: Nitrogen (flow rate 50 ml/min)

Starting temperature: 20° C.

Rising speed of temperature: 10° C./min

Maximum temperature: 150° C.

Holding time: 0

Lowering speed of temperature: 10° C./min

Minimum temperature: 20° C.

Holding time: 0

Rising speed of temperature: 10° C./min

Maximum temperature: 150° C.

The measurement results were analyzed using data analysis software TA-60 version 1.52 from Shimadzu Corporation.

The glass transition temperature (Tg) is measured by specifying a range of ±5° C. as a central focus on a maximum peak point on the lowest temperature side of a DSC differential curve in the second rise of temperature, and a peak temperature is determined using a peak analysis function of the analysis software. Next, the maximum endothermic temperature is determined of the DCS curve using the peak analysis function of the analysis software in the range of the peak temperature ±5° C. This is the glass transition temperature.

The melting point is measured by specifying a range of ±5° C. as a central focus on a maximum peak point on the lowest temperature side of a DSC differential curve in the second rise of temperature, and a peak temperature is determined using a peak analysis function of the analysis software. This is the melting point.

When the DSC curve does not return to heating direction after the endotherm, it is a glass transition temperature. When the DSC curve does not return to the DSC curve (base line) before the endotherm, it is a melting point.

### <Weight Reduction Rate>

The weight reduction rate was measured by the above-mentioned TGA method.

### Example 1-1

A toner material liquid (oil phase) and an aqueous medium (aqueous phase) were prepared as follows.

### <Preparation of Toner Material Liquid (Oil Phase)>

### [Synthesis of Unmodified (Low-Molecular-Weight) Polyester]

229 parts of an adduct of bisphenol A with 2 moles of ethyleneoxide, 528 parts of an adduct of bisphenol A with 3 moles of propyleneoxide, 207 parts terephthalic acid, 45 parts of adipic acid and 2 parts of dibutyltinoxide were polycondensated in a reactor vessel including a cooling pipe, a stirrer and a nitrogen inlet pipe for 7 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 185° C. to prepare an unmodified polyester.

The unmodified polyester had a number-average molecular weight (Mn) of 2,600, a weight-average molecular weight (Mw) of 6,600, a glass transition temperature (Tg) of 44° C. and an acid value of 23 mg KOH/g.

### [Preparation of Masterbatch (MB-1)]

1,200 parts of water, 540 parts of carbon black Printex 35 from Degussa A.G. having a DBP oil absorption of 42 ml/100 mg and a pH of 9.5, 1,210 parts of the unmodified polyester were mixed by a Henschel mixer from Mitsui Mining Co., Ltd. After the mixture was kneaded by a two-roll mill having a surface temperature of 160° C. for 40 min, the mixture was extended by applying pressure, cooled and pulverized by a pulverizer from Hosokawa Micron Limited to prepare a masterbatch (MB-1).

### [Preparation of Wax Dispersion (1-1)]

In a reaction container including a stirring bar and a thermometer, 378 parts of the unmodified polyester, 110 parts of a wax (VICTORY Wax from Toyo ADL Corp., having a melting point of 58° C., a melt viscosity at 140° C. of 12 mPa·S, a melt viscosity at 100° C. of 13 mPa·S, a melt viscosity at 160° C. of 9 mPa·S, a difference between the melt viscosities at 100° C. and 160° C. of 4 mPa·S and a weight reduction ratio of 0.02% by weight/min when measured by TGA method), 49.5 parts of a wax dispersant (BE SQUARE 185 Wax from Toyo ADL Corp., having a melting point of 68° C., a melt viscosity at 140° C. of 15 mPa·S, a melt viscosity at 100° C. of 18 mPa·S, a melt viscosity at 160° C. of 14 mPa·S, a difference between the melt viscosities at 100° C. and 160° C. of 4 mPa·S and a weight reduction ratio of 0.007% by weight/min when measured by TGA method) and 947 parts of ethylacetate were mixed and heated to have a temperature of 85° C. while stirred. After the mixture was left for 5 hrs at 85° C., it was cooled to have a temperature of 30° C. for 1 hr to prepare a wax dispersion (1-1).

### [Preparation of Organic Solvent Phase]

The wax dispersion (1-1) was placed in 500 parts of the masterbatch (MB-1) and 500 parts of ethylacetate such that the wax was included in a toner in an amount of 4.0 parts by weight, and the mixture was mixed for 2 hrs to prepare a material solution.

1,324 parts of the material solution 1 were transferred into another vessel, and the carbon black and the wax therein were dispersed by a beads mill (Ultra Visco Mill from Aimex Co., Ltd.) for 3 passes under the following conditions:

liquid feeding speed of 1 kg/hr; peripheral disc speed of 6 m/sec; and filling zirconia beads having diameter of 0.5 mm for 80% by volume.

Next, 1,325 parts of an ethylacetate solution of the unmodified polyester having a concentration of 65% were added to the material solution and the mixture was stirred by the beads mill for 1 pass under the same conditions to prepare an organic solvent phase. The organic solvent phase had a solid content concentration of 50% by weight when heated at 130° C. for 30 min.

### [Synthesis of Prepolymer]

682 parts of an adduct of bisphenol A with 2 moles of ethyleneoxide, 82 parts of an adduct of bisphenol A with 2 moles of propyleneoxide, 283 parts terephthalic acid, 23 parts of trimellitic acid anhydride and 2 parts of dibutyltinoxide were mixed and reacted in a reactor vessel including a cooling pipe, a stirrer and a nitrogen inlet pipe for 7 hrs at a normal pressure and 235° C. Further, after the mixture was depressurized to 10 to 15 mm Hg and reacted for 5 hrs to prepare an [intermediate polyester 1-1]. The [intermediate polyester 1-1] had a number-average molecular weight of 2,300, a weight-average molecular weight of 9,750, a peal molecular weight of 3,100, a Tg of 53° C. and an acid value of 0.7 mg KOH/g and a hydroxyl value of 50 mg KOH/g.

Next, 411 parts of the [intermediate polyester 1-1], 87 parts of isophoronediisocyanate and 500 parts of ethyl acetate were reacted in a reactor vessel including a cooling pipe, a stirrer and a nitrogen inlet pipe for 5 hrs at 100° C. to prepare a [prepolymer 1-1]. The [prepolymer 1-1] included a free isocyanate in an amount of 1.42% by weight

### [Synthesis of Ketimine (Active-Hydrogen-Group-Containing Compound)]

170 parts of isophoronediamine and 75 parts of methyl ethyl ketone were reacted at 50° C. for 5 hrs in a reaction vessel including a stirrer and a thermometer to prepare a ketimine compound (active-hydrogen-group-containing compound).

The ketimine compound (active-hydrogen-group-containing compound) had an amine value of 418 mg KOH/g.

### [Preparation of Toner Material Liquid]

In a reaction container, 748 parts of the organic solvent phase, 114 parts of the prepolymer and 2.8 parts of the ketimine compound were mixed by TK-type homomixer from Tokushu Kika Kogyo Co., Ltd. at 7.3 m/s for 1 min to prepare a toner material liquid.

### <Preparation of Aqueous Medium (Phase)>

### [Preparation of Organic Particulate Resin Dispersion)

683 parts of water, 22 parts of a sodium salt of an adduct of a sulfuric ester with ethyleneoxide methacrylate (ELEMINOL RS-30 from Sanyo Chemical Industries, Ltd.), 78 parts of styrene, 78 parts of methacrylate, 120 parts of butylacrylate and 1 part of persulfate ammonium were mixed in a reactor vessel including a stirrer and a thermometer, and the mixture was stirred for 15 min at 450 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted at 75° C. for 5 hrs to prepare an aqueous dispersion (an organic particulate resin dispersion) of a vinyl resin (a copolymer of a sodium salt of an adduct of styrene-methacrylate-butylacrylate-sulfuric ester with ethyleneoxide methacrylate).

The volume-average particle diameter (Dv) of the organic particulate resin included in the organic particulate resin dispersion measured by a particle diameter distribution measurer nanotrac UPA-150EX from NIKKISO CO., LTD. was 54 nm. The organic particulate resin dispersion was partially dried to separate the resin therefrom, and the resin had a glass transition temperature (Tg) of 48° C. and a weight-average molecular weight (Mw) of 440,000.

990 parts of water, 37 parts of an aqueous solution of sodium dodecyldiphenyletherdisulfonate having a concentration of 48.5% (ELEMINOL MON-7 from Sanyo Chemical Industries, Ltd.), 15 parts of the organic particulate resin dispersion and 90 parts of ethylacetate were mixed and stirred to prepare a lacteous liquid (aqueous phase).

### (Toner Granulation Process)

### [Emulsification and Dispersion Process]

1,210 parts of the aqueous phase 1 were added to the toner material liquid and mixed by TK-type homomixer from Tokushu Kika Kogyo Co., Ltd. at 18 m/s for 20 min to prepare an emulsified slurry.

### [De-Solvent Process]

The emulsified slurry was placed in a reaction container including a stirring bar and a thermometer, and de-solvented at 30° C. for 7 hrs and aged at 45° C. for 5 hrs to prepare a dispersion slurry.

### [Washing & Drying Process]

After 100 parts of the dispersion slurry was filtered under reduced pressure to prepare a filtered cake, 100 parts of ion-exchanged water were added to the filtered cake and mixed by TK-type homomixer at 10.0 m/s for 10 min, and the mixture was filtered. 100 parts of ion-exchanged water were further added to the filtered cake and mixed by TK-type homomixer at 12.0 m/s for 10 min, and the mixture was filtered under reduced pressure. Further, 100 parts of an aqueous solution of 10% sodium hydrate were added to the filtered cake and mixed by TK-type homomixer at 11.0 m/s for 10 min, and the mixture was filtered. Further, 310 parts of ion-exchange water were added to the filtered cake and mixed by TK-type homomixer at 11.0 m/s for 10 min, and the mixture was filtered. This operation was repeated again to prepare a final filtered cake.

### [Surface-Treatment Process]

300 parts of ion-exchange water were added to the filtered cake and mixed by TK-type homomixer at 7,000 rpm to prepare a toner dispersion. The toner dispersion was heated and left for 40 min to cool after T1 became 60° C. After cooled, the electroconductivity of the toner dispersion was measured. A surfactant concentration of the toner dispersion was determined from a standard curve of the surfactant concentration previously prepared. The surfactant concentration was 0.05% by weight. Next, the toner dispersion was filtered.

The final filtered cake was dried by an air drier at 45° C. for 48 hrs and sieved by a mesh having an opening of 75 μm to prepare mother toner particles of Example 1-1.

### [External Additive Process]

1.4 parts of hydrophobic silica and 0.7 parts of hydrophobic titanium oxide were mixed with 100 parts of the mother toner particles by HENSCHEL MIXER from Mitsui Mining Co., Ltd. to prepare a toner of Example 1-1.

FIG. 1 is a transmission electron microscopic (TEM) cross-sectional picture (100 thousands magnifications) of the toner of Example 1-1.

The Dv, Dn and DV/Dn of the toner were measured by the above-mentioned method.

### Example 1-2

The procedure for preparation of the toner in Example 1-1 was repeated to prepare a toner except for replacing the wax dispersant with BE SQUARE 195 Wax from Toyo ADL Corp., having a melting point of 84° C., a melt viscosity at 140° C. of 10 mPa·S, a melt viscosity at 100° C. of 10 mPa·S, a melt viscosity at 160° C. of 8 mPa·S, a difference between the melt viscosities at 100° C. and 160° C. of 4 mPa·S and a weight reduction ratio of 0.009% by weight/min when measured by TGA method.

### Example 1-3

The procedure for preparation of the toner in Example 1-2 was repeated to prepare a toner except for replacing the wax with Paraffin HNP-9 from Nippon Seiro Co., Ltd., having a melting point of 75° C., a melt viscosity at 140° C. of 5 mPa·S, a melt viscosity at 100° C. of 8 mPa·S, a melt viscosity at 160° C. of 4 mPa·S, a difference between the melt viscosities at 100° C. and 160° C. of 4 mPa·S and a weight reduction ratio of 0.04% by weight/min when measured by TGA method.

### Example 1-4

The procedure for preparation of the toner in Example 1-2 was repeated to prepare a toner except for replacing the wax with a polypropylene wax 660P from Sanyo Chemical Industries, Ltd., having a melting point of 130° C., a melt viscosity at 140° C. of 12 mPa·S, a melt viscosity at 100° C. of 16 mPa·S, a melt viscosity at 160° C. of 9 mPa·S, a difference between the melt viscosities at 100° C. and 160° C. of 7 mPa·S and a weight reduction ratio of 0.02% by weight/min when measured by TGA method.

### Comparative Example 1-2

The procedure for preparation of the toner in Example 1-1 was repeated to prepare a toner except for replacing the wax with Paraffin HNP-10 from Nippon Seiro Co., Ltd., having a melting point of 75° C., a melt viscosity at 140° C. of 4 mPa·S, a melt viscosity at 100° C. of 8 mPa·S, a melt viscosity at 160° C. of 2 mPa·S, a difference between the melt viscosities at 100° C. and 160° C. of 6 mPa·S and a weight reduction ratio of 0.8% by weight/min when measured by TGA method.

### Comparative Example 1-2

The procedure for preparation of the toner in Example 1-1 was repeated to prepare a toner except for replacing the wax with LUVAX2191 from Nippon Seiro Co., Ltd., having a melting point of 88° C., a melt viscosity at 140° C. of 19 mPa·S, a melt viscosity at 100° C. of 30 mPa·S, a melt viscosity at 160° C. of 12 mPa·S, a difference between the melt viscosities at 100° C. and 160° C. of 18 mPa·S and a weight reduction ratio of 0.9% by weight/min when measured by TGA method.

The volatility, inner contamination (inner wall contamination), fixability, filming resistance, paper backside contamination, transferability, uneven transfer and foggy images were evaluated using the thus prepared toners. The results are shown in Tables 1-1 to 1-4. The fixability, filming resistance, paper backside contamination, transferability, uneven transfer and foggy images were evaluated under the following conditions. The volatility and inner contamination (inner wall contamination) were visually evaluated.

### <Fixability>

imagio Neo C450 from Ricoh Company, Ltd., modified to have a belt heating fixer in FIG. 5 was used.

The belt heating fixer 25 in FIG. 5 includes a heat roller R3 including a heat source H1 at the core, an endless fixing belt 26 suspended by a fixing roller R1, and a pressure roller 27 pressing the fixing roller R1 with a pressure spring P1 through the fixing belt 26. The pressure roller 27 including a heat source H2 at the core is capable of heating and pressing a toner in a recording material P guided by a guide G. The fixing belt 26 is applied with a predetermined tension by a heat roller R3 pulled by a spring P2, and further scrapable with an outer circumference of a cleaning roller R4 cleaning the surface of the fixing belt 26. The fixing belt 26 is a three-layered belt including a 100 μm thick substrate formed of polyimide, a 100 μm thick intermediate elastic layer formed of silicon rubber and a 15 μm surface offset prevention layer formed of PFA. The fixing roller R1 includes an outer circumferential layer formed of a silicon foamed material. The pressure roller 27 has a surface pressure of 1×10⁵ Pa and includes a 1 mm thick metallic cylinder formed of SUS as a core, a 2 mm thick intermediate layer formed of aluminum and a 2 mm thick outermost offset prevention layer formed of PFA tube and silicon rubber.

Toner friction test was performed by measuring a density on a cotton after an image was frictionized thereby for 5 times, using a clock meter from Toyo Seiki Seisaku-sho, Ltd.

(1) Low-temperature fixability (5 grades) [Minimum in Table 1]

Less than 120° C.: Very good

120 to less than 130° C.: Good

130 to less than 140° C.: Average

140 to less than 150° C.: Poor

Not less than 150° C.: Very poor

(2) Toner friction (4 grades)

Less than 0.1: Very good

Less than 0.2: Good

0.2 to less than 0.6: Poor

Not less than 0.6: Very poor

(3) Hot offset resistance (5 grades)

Not less than 201° C.: Very good

191 to 200° C.: Good

181 to 190° C.: Average

171 to 180° C.: Poor

less than 170° C.: Very poor

### <Filming Resistance>

Toner filming on a developing roller or a photoreceptor in color electrophotographic image forming apparatus IPSiO Color 8100 from Ricoh Company, Ltd. was visually observed after 50,000 images were produced and evaluated on the following standards.

Very good: No filming

Good: Almost no filming

Poor: Stripe filming was partially observed

Very poor: Filming was totally observed

### <Paper Backside Contamination>

After 1,000,000 black solid images were produced by imagio Neo C450 from Ricoh Company, Ltd., a blank image was produced to evaluate the backside contamination thereof on the following standards.

Very good: No backside contamination

Good: Between “Very good” and “Average”

Average: Slight backside contamination

Poor: Between “Very poor” and “Average”

Very poor: Backside contamination was apparently observed

### <Transferability(%)>

DocuColor8000 Digital Press form Fuji Xerox Co., Ltd., modified to have controllable linear speed and transfer time was used to produce A4 size solid images having a toner adherence amount of 0.6 mg/cm² with each toner. The first transferability and the second transferability were determined by the following formulae (3) and (4), respectively after 100,000 and 1,000,000 images were produced.

First transferability=(Toner amount transferred onto intermediate transferer/Toner amount transferred onto photoreceptor)×100 (3)

Second transferability=(Toner amount transferred onto intermediate transferer−Untransferred toner amount on intermediate transferer)/(Toner amount transferred onto intermediate transferer)×100 (4)

[Evaluation Standard]

Very good: Not less than 90%

Good: Not less than 85% less than 90%

Poor: Not less than 80% less than 85%

Very poor: Less than 80%

### <Uneven Transfer>

A black solid image was produced by imagio Neo C450 from Ricoh Company, Ltd. to visually observe uneven transfer and evaluate on the following standards.

Very good: No uneven transfer

Good: No problem in practical use

Poor: Practically usable

Very poor: Problem in practical use

### <Foggy Image>

After imagio Neo C450 from Ricoh Company, Ltd., having A cleaning blade and a charging roller contacting the photoreceptor produced 100,000 A4 images having black and blank solid images at an interval of 1 cm in a direction perpendicular to a rotational direction of the developing sleeve, a blank images was produced to evaluate foggy image on the following standards.

Very good: No uneven transfer

Good: No problem in practical use

Poor: Practically usable

Very poor: Problem in practical use

TABLE 1-1

| | WAX | | | |
|---|---|---|---|---|
| | Name | 140 | 100-160 | WR |
| Example 1-1 | VICTRORY | 12 | 4 | 0.02 wt %/min |
| | Wax | | | |
| Example 1-2 | VICTRORY | 12 | 4 | 0.02 wt %/min |
| | Wax | | | |
| Example 1-3 | HNP-9 | 5 | 4 | 0.04 wt %/min |
| Example 1-4 | 660P | 12 | 7 | 0.02 wt %/min |
| Comparative | HNP-10 | 4 | 6 | 0.8 wt %/min |
| Example 1-1 | | | | |
| Comparative | LUVAX2191 | 19 | 18 | 0.9 wt %/min |
| Example 1-2 | | | | |

140: Melt viscosity at 140° C.

100-160: Difference between a melt viscosity at 100° C. and a melt viscosity at 160° C.

WR: Weight reduction by TGA method

TABLE 1-2

| | WAX dispersant | | | |
|---|---|---|---|---|
| | Name | 140 | 100-160 | WR |
| Example 1-1 | BE SQUARE | 15 | 4 | 0.007 wt %/min |
| | 185 Wax | | | |
| Example 1-2 | BE SQUARE | 10 | 4 | 0.009 wt %/min |
| | 195 Wax | | | |
| Example 1-3 | BE SQUARE | 10 | 4 | 0.009 wt %/min |
| | 195 Wax | | | |
| Example 1-4 | BE SQUARE | 10 | 4 | 0.009 wt %/min |
| | 195 Wax | | | |
| Comparative | — | — | — | — |
| Example 1-1 | | | | |
| Comparative | — | — | — | — |
| Example 1-2 | | | | |

TABLE 1-3

| | Toner | | | | | |
|---|---|---|---|---|---|---|
| | PD | Toner | | Fixability | | |
| | (μm) | WR | IWC | Min. | Friction | HO |
| Example 1-1 | 4.8 | 0.01 wt %/min | None | Very | Very | Very |
| | | | | good | good | good |
| Example 1-2 | 4.2 | 0.01 wt %/min | None | Very | Very | Very |
| | | | | good | good | good |
| Example 1-3 | 5.3 | 0.02 wt %/min | None | Very | Very | Very |
| | | | | good | good | good |
| Example 1-4 | 8.8 | 0.03 wt %/min | None | Very | Good | Good |
| | | | | good | | |
| Comparative | 5.3 | 0.6 wt %/min | Much | Poor | Poor | Good |
| Example 1-1 | | | | | | |
| Comparative | 6.1 | 0.6 wt %/min | Much | Very | Very | Poor |
| Example 1-2 | | | | poor | poor | |

PD: Particle diameter
IWC: Inner wall contamination
HO: Hot offset resistance

PD: Particle diameter

IWC: Inner wall contamination

HO: Hot offset resistance

TABLE 1-4

| | Filming | | | | Foggy |
|---|---|---|---|---|---|
| | resistance | PBC | TR | UTR | images |
| Example 1-1 | Very | Very | Very | Very | Very |
| | good | good | good | good | good |
| Example 1-2 | Very | Very | Very | Very | Very |
| | good | good | good | good | good |
| Example 1-3 | Very | Very | Very | Very | Very |
| | good | good | good | good | good |
| Example 1-4 | Good | Very | Very | Very | Good |
| | | good | good | good | |
| Comparative | Good | Good | Poor | Good | Good |
| Example 1-1 | | | | | |
| Comparative | Good | Good | Good | Good | Poor |
| Example 1-2 | | | | | |

PBC: Paper Backside Contamination

TR: Transferability

UTR: Uneven transfer

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2010-096723 filed on Apr. 20, 2010, the entire contents of which are herein incorporated by reference.

What is claimed is:

1. A toner, comprising:
a binder;
a colorant; and
a wax comprising a molecular chain constituted of only a C—H bond and a C—C bond, and having a melting point of from 50 to 78° C. and a melt viscosity of from 5 to 15 mPa·S at 140° C.,
wherein the toner has a weight reduction rate of from 0.001 to 0.1% by weight/min when measured by TGA (Thermogarvimetric Analysis) method in an atmosphere at 165° C. for 10 min.

2. The toner of claim 1, wherein the wax is at least one member selected from the group consisting of microcrystalline wax, paraffin wax, polyethylene wax, polypropylene wax and Sasol wax, and has a weight reduction rate of from 0.005 to 0.5% by weight/min when measured by TGA method.

3. The toner of claim 1, wherein the toner is prepared by a method comprising:
emulsifying or dispersing a toner material liquid comprising the binder, the colorant and the wax in an aqueous medium including a first surfactant to prepare an emulsion or a dispersion; and
subjecting the emulsion or dispersion to a surface treatment with a second surfactant having a concentration not less than 0.1 and less than 2.0 times of a critical micellar concentration thereof.

4. The toner of claim 3, wherein the toner material liquid further comprises a wax dispersant in an amount of from 10 to 300% by weight based on total weight of the wax.

5. The toner of claim 1, wherein the binder comprises at least one of a binder resin and a precursor thereof, wherein the precursor is a polymer reactable with an active hydrogen group of a compound including the active hydrogen group.

6. The toner of claim 5, wherein the polymer reactable with the active hydrogen group has a weight-average molecular weight of from 3,000 to 45,000.

7. The toner of claim 1, wherein the binder resin comprises a polyester resin.

8. The toner of claim 7, wherein the binder resin comprises the polyester resin in an amount of from 50 to 100% by weight.

9. The toner of claim 7, wherein the polyester resin comprises a tetrahydrofuran (THF)-soluble component having a weight-average molecular weight of from 3,000 to 30,000.

10. The toner of claim 7, wherein the polyester resin has an acid value of from 12 to 30 mg KOH/g.

11. The toner of claim 7, wherein the polyester resin has a glass transition temperature of from 35 to 65° C.

12. The toner of claim 1, wherein the toner comprises a THF-insoluble component in an amount of from 5 to 25% by weight.

13. The toner of claim 1, wherein the wax dispersed in the toner material liquid has a volume-average particle diameter of from 0.1 to 2 μm.

14. The toner of claim 1, wherein the toner has a ratio (Dv/Dn) of a volume-average particle diameter (Dv) to a number-average particle diameter (Dn) of from 1.00 to 1.25.

15. The toner of claim 1, wherein the toner has the volume-average particle diameter (Dv) of from 1 to 8 μm.

16. The toner of claim 1, wherein the toner has a glass transition temperature of from 40 to 70° C.

17. The toner of claim 3, wherein the toner material liquid further comprises a wax dispersant comprising having a molecular chain constituted of only C—H and C—C bonds, and wherein the wax and the wax dispersant have a difference between a melt viscosity at 100° C. and a melt viscosity at 160° C. of from 1 to 10 mPa·S.

18. A developer comprising the toner according to claim 1 and a carrier.

19. A process cartridge detachable from image forming apparatus, comprising:
an electrostatic latent image bearer configured to bear an electrostatic latent image; and
an image developer configured to develop the electrostatic latent image with the toner according to claim 1,
in a body.

20. An image forming apparatus, comprising:
an electrostatic latent image bearer configured to bear an electrostatic latent image;
a charger configured to charge the surface of the electrostatic latent image bearer;
an irradiator configured to irradiate the surface of the electrostatic latent image bearer to from an electrostatic latent image thereon;
an image developer configured to develop the electrostatic latent image with the toner according to claim 1 to form a toner image,
a transferer configured to transfer the toner image onto a recording medium, and
a fixer configured to fix the toner image on the recording medium.
